(19) United States
(12) Patent Application Publication
(10) Pub. No.: US 2003/0013623 A1
(43) Pub. Date: Jan. 16, 2003

(54) Olefin copolymer viscocity index improvers

(76) Inventors: Kwok-Leung Tse, Brooklyn, NY (US); Stuart Briggs, Edison, NJ (US)

Correspondence Address: Infineum USA L.P., Law Department, 1900 East Linden Avenue, P. O. Box 710, Linden, NJ, 07036-0710, US

(21) Appl. No.: 09/845,756

(22) Filed: May 1, 2001

(51) Int. Cl. C10M 143/00; C08L 23/00

(52) U.S. Cl. 508/591; 508/191; 508/197; 508/198; 508/240; 585/12

(57) ABSTRACT

Oil soluble viscosity index improver composition comprising a mixture of: (A) at least one molecular weight degraded copolymer of ethylene and at least one other alpha-olefin monomer; and (B) at least one substantially undegraded copolymer of ethylene and at least one other alpha-olefin monomer. The ethylene alpha-olefin copolymers before degradation can be polymerized by a variety of available technologies including Ziegler-Natta, metallocene and diimine catalysis, as well as batch, continuous stirred tank and tubular reactors to produce copolymers having both broad or narrow molecular weight and compositional distributions. Use of degraded/non-degraded copolymer mixtures facilitates the preparation of viscosity index improvers for oils having targeted levels of shear stability index.

### BACKGROUND OF THE INVENTION

This invention relates to mixtures of degraded and undegraded olefin copolymers; in particular, olefin copolymers comprising ethylene and being of a certain type useful as viscosity index improver additives for oleaginous compositions such as, for example, lubricating oil and fuel compositions. More particularly, this invention is concerned with mixtures of copolymers of ethylene and at least one other alpha-olefin wherein the degraded ethylene copolymer, generally having been reduced in molecular weight, displays a reduced (improved) value of shear stability index (SSI). Undegraded copolymers useful in the mixture and as a starting point material for the degraded copolymer can be prepared by various copolymerization processes using well-known, as well as newly developed, catalyst systems. Useful undegraded copolymers can have broad or narrow molecular weight distributions and can be comprised of compositionally uniform polymer chains or, alternatively, segmented copolymer chains with compositions that are intramolecularly heterogeneous and intermolecularly homogeneous. These mixtures comprising the degraded copolymer may be used directly as viscosity index improver additives. Alternatively, the degraded and undegraded copolymers may be grafted with various grafting materials to provide mixtures useful as multifunctional viscosity index improver additives. Furthermore, the undegraded and degraded grafted ethylene copolymer mixtures may be reacted with polyamines containing at least two reactive amine groups or polyols to provide mixtures useful as viscosity index improver-dispersant additives for oleaginous compositions.

It is known that the viscosity index of an oleaginous composition such as lubricating oil can be increased or improved by incorporating therein certain polymeric materials which function as viscosity index improvers. Known viscosity index improvers include polyisobutene and copolymers of ethylene and other hydrocarbon olefins, including alpha-olefins such as propylene. It is also known that viscosity index improvers can be degraded by mechanical, thermal and/or oxidative methods to modify (i.e., lower and thereby improve) their shear stability index. Furthermore, it is also known that these viscosity index improvers can be grafted with grafting materials such as, for example, maleic anhydride and the grafted material then reacted with a polyamine or a polyol to form multifunctional viscosity index improvers.

Generally, the polymeric materials useful as viscosity index improvers are those having number average molecular weights (Mn) of from about 15,000 to about 250,000, or even higher; preferably from about 20,000 to about 150,000. However, some copolymers at the lower end of the molecular weight range are different to process, isolate and handle, or are relatively more expensive to produce than the higher molecular weight versions. Additionally, it may be difficult or expensive to directly polymerize copolymers having the specific performance characteristics, particularly, the desired SSI. It is also known that olefin and diolefin homopolymers and ethylene-alpha-olefin copolymers may be degraded, thereby reducing the molecular weight thereof. Such degradation is known to be accomplished, for example, by shear assisted oxidation of the polymers and copolymers in air in a mechanical mixer, such as in an extruder, masticator, Banbury mixer, rubber mill, or the like, and by heating the polymers and copolymers, sometimes in the presence of air.

U.S. Pat. No. 3,313,793 describes a degradation process that involves (a) the formation of a solution of a conjugated diene polymer, (b) combining therewith a peroxide and a copper source such as copper, a copper halide or a copper carboxylate, (c) heating the resulting mixture in the substantial absence of oxygen, and (d) recovering a diene polymer product having a substantially reduced average molecular weight.

U.S. Pat. No. 3,316,177 discloses a functional fluid containing a sludge inhibiting detergent comprising the polyamine salts of the reaction product of the maleic anhydride with a degraded and oxidized interpolymer of propylene and ethylene. The interpolymers from which the oxidized, degraded interpolymers are derived typically have molecular weights of at least about 50,000. The interpolymers are oxidized and degraded by heating them at a temperature of at least about 100° C. in the presence of oxygen or air. Such degradation usually is characterized by a substantial reduction in the molecular weight of the interpolymer.

U.S. Pat. No. 3,332,926 relates to the thermal degradation of polyolefins, including ethylene-propylene copolymers, to produce relatively low molecular weight polymers which are useful, for example, as wax substitutes, blending agents, coating compositions and, in general, in fields where hydrocarbon resins and waxes find utility. The degradation process described in the patent comprises mixing a crystalline starting polymer with from 0.075% to 10% by weight of a metal salt of carboxylic acid and heating the mixture in an atmosphere which is substantially free from oxygen to a temperature of about 275° C. to 450° C., until a substantial reduction in the molecular weight of the polymer takes place.

U.S. Pat. No. 3,345,352 relates to a catalytic process for the thermal degradation of the polyolefins, including copolymers of ethylene and propylene. The degradation process involves heating a mixture of a crystalline polyolefin and an oxide or carbonate of an alkali metal, alkaline earth metal, or certain selected transition metals such as copper, iron, titanium, vanadium, etc. in an atmosphere substantially free of oxygen to a temperature of from 275° C. to 450° C. for a minimum time period of at least five minutes.

U.S. Pat. No. 3,687,849 relates to lubricants containing oil-soluble graft polymers derived from degraded ethylene-propylene interpolymers. The interpolymers from which the degraded polymers are derived usually have a molecular weight of about 50,000-800,000, and the degraded interpolymers are prepared by heating the interpolymer, or a fluid solution of such interpolymer, in an inert solvent, at a temperature of at least about 140° C. in the presence of oxygen or air. The degradation of the interpolymer is characterized by a substantial reduction of its molecular weight. A similar disclosure is set forth in U.S. Pat. No. 3,687,905.

U.S. Pat. No. 3,769,216 relates to polymer derivatives that are produced by reacting a primary or secondary amine and a mechanically degraded, oxidized atactic ethylene propylene copolymer, and to automotive lubricating oils containing such polymer derivatives. The ethylene propylene copolymer is mechanically degraded in the presence of oxygen and in the absence of any solvent in a closed vessel equipped with shearing blades. A typical apparatus of this type is described as a device containing counter-rotating helical blades and known as a “Brabender Torque Rheometer.”

U.S. Pat. No. 4,113,636 discloses the mechanical degradation at elevated temperatures and in the presence of air or oxygen-containing gas, of copolymers comprising about 68 to 80 mole % ethylene and one or more C₃-C₈ alpha-olefins to form an oxygenated-degraded polymer which is then reacted with an amine compound. The resulting aminated polymers are useful as viscosity index improving additives.

U.S. Pat. No. 4,074,033 and 4,201,732 relate to a process for improving the processability of high molecular weight neoprene polymers. The process comprises treating a solution of the polymers in an organic solvent with an organic peroxide, in the presence of oxygen, to reduce the molecular weight of the neoprene and to lower the viscosity of the solution. The process may be conducted at room temperature with or without agitation, and an accelerator such as a cobalt salt or other transition metal salt may be employed.

U.S. Pat. No. 4,327,237 discloses the preparation of mono-olefin copolymer viscosity index improvers by thermal cracking at 250° C. to 350° C. in a mineral oil solution with vigorous stirring and in the presence of a free radical scavenger.

U.S. Pat. No. 4,464,493 provides a method for preparing a solution of a solid high molecular weight ethylene propylene copolymer (EPM) or terpolymer (EPDM) in oil by reducing the polymer molecular weight and narrowing its molecular weight distribution by passage through an extruder at elevated temperature. The polymer is extruded as small particles which are taken directly into solution by circulating hot oil across the extruder die face.

Oxidative degradation of an olefinic polymer in solution is also disclosed in U.S. Pat. No. 4,743,391. The method avoids the introduction of oxygen from a separate source and instead uses an oxidant mixture of peroxide and hydroperoxide. The polymers include all homopolymers and copolymers derived from olefinically unsaturated hydrocarbon monomers, including ethylene propylene copolymers and terpolymers having Mn in the range of 10,000 or 15,000 to 200,000. The oxidized polymers have viscosity average molecular weights of from about one-half to about one-tenth of the original material as well as a carbonyl group on substantially each molecule. It is disclosed that the terpolymers can be polymerized using Ziegler-Natta catalysts. The degraded and oxidized polymer product can be used as such or further derivatized for use as a viscosity index improver.

U.S. Pat. No. 5,006,608 discloses a catalytic oxidative shear degradation process as applied to an ethylene-alpha-olefin copolymer in order to reduce its thickening efficiency. The process employs as a catalyst an oil soluble transition metal salt of an organic acid and operates in the presence of oxygen at elevated temperature, e.g., from about 110° to 250° C. A peroxide is used as a supplemental aid to effect degradation.

U.S. Pat. No. 5,391,617 discloses an ethylene-propylene co- and/or terpolymer blend having a Mn in the range of 20,000 to 150,000 and Mw/Mn of 1.5 to 5. The blend is prepared in the absence of a solvent by blending and shearing at high temperature two components simultaneously, an essentially amorphous low ethylene copolymer and a partially crystalline higher ethylene copolymer (each copolymer's initial Mn=40,000 to 250,000 and Mw/Mn=2 to 7 and the polymers include those which have been previously grafted or functionalized with various known monomers that are capable of producing a dispersant viscosity index improver). Both the Mn and Mw/Mn of each of the components are said to be reduced during the blending and shearing operation. Simultaneous blending and shearing of the two components is required and the patent discloses that different results are obtained if the components are separately sheared and degraded to reduce the Mn and Mw/Mn and subsequently blended with one another. Divisional patents have also granted: U.S. Pat. No. 5,451,630 (claims directed to a lubricating oil concentrate and composition incorporating the polymer blend of the parent patent); 5,451,636 (claims directed to a process for producing the blend of the parent patent) and 5,837,773 (claims directed to a blend and process for producing the blend to a lower molecular weight blend target, Mn=300 to 5,000, as well as a post-degradation grafting process and composition based on the lower Mn product). The disclosure of U.S. Pat. No. 5,391,617 is incorporated herein by reference to the extent permitted.

U.S. Pat. No. 5,244,590 discloses degraded ethylene alpha olefin copolymers useful as viscosity index improvers for oils. The copolymers are produced according to the “tubular process”, e.g., as described in U.S. Pat. No. 4,804,794, and have specifically defined molecular weight distribution and compositional distribution characteristics. Mechanical and thermal processes are disclosed as suitable for degrading or reducing the molecular weight of these copolymers.

Published European Patent Application 637611 A2 discloses the simultaneous blending and shearing of a low ethylene content ethylene-propylene polymer and a higher ethylene content ethylene-propylene polymer to reduce their molecular weights and molecular weight distributions. The resulting polymer mixture is said to function as a shear stable viscosity index improver with improved low temperature properties. In the absence of simultaneous treatment the resulting mixture is said to have different, presumably inferior, properties. The modified mixture is disclosed as useful in applications other than viscosity index improvement and it is in such other applications that mixtures with other polymers is disclosed, e.g., as an impact modifier for plastics such as nylon, polyesters, polyolefins, as an antiozonant for rubber/rubber blends, etc.

Published European Patent Application 638611 A2 discloses a dimensionally stable polymer blend useful in a lubricating oil composition wherein the blend comprises partially crystalline and amorphous ethylene copolymers. Blends were prepared by solution blending. Another method mentioned for preparing blends was mixing of the solids using a masticator or extruder. It is also said that the higher molecular weight, non-shear stable copolymer, can be reduced in molecular weight. Only solution blending of individual components is exemplified.

Wo 96/17041 discloses polymer blends of amorphous or partially crystalline olefin copolymers, e.g., ethylene-propylene copolymers or terpolymers, and star branched polymers, e.g., styrene-isoprene copolymers. These blends are also said to be dimensionally stable, oil soluble and useful as viscosity index improvers. Blends can be prepared by solution blending of the components or by blending in a masticator or extruder. Polymer blends are prepared only by dissolving pieces of each of the component polymers in a suitable solvent and evaporating the solvent.

Grafting high molecular weight ethylene alpha-olefin copolymers, either degraded or undegraded, with acid moieties such as maleic anhydride, followed by reaction with an amine to form a composition useful as a multifunctional viscosity index improver, e.g., viscosity index improver-dispersant, oil additive is also known and is disclosed in several of the above patents as well as others. For example, U.S. Pat. No. 4,089,794 discloses ethylene copolymers derived from about 2 to 98 wt % ethylene, and one or more C₃ to C₂₈ alpha-olefins, such as ethylene-propylene copolymers, which are solution-grafted with an ethylenically unsaturated carboxylic acid material, and thereafter reacted with a polyfunctional material reactive with carboxyl groups. The resulting polymers are useful as dispersant additives for lubricating oils and hydrocarbon fuels, and as multifunctional viscosity index improvers provided their molecular weight is above 10,000. The patent discloses an ethylene copolymer grafted with maleic anhydride using peroxide in a lubricating oil solution, wherein the grafting is preferably carried out under nitrogen, followed by reaction with polyamine. It is also known to carry out such grafting reactions in the melt, e.g., in an extruder. In some instances, polymer degradation is associated with the preparation of the derivatized polymer. For example, U.S. Pat. No. 5,075,383 teaches a process for the production of a dispersant/antioxidant oil additive composition based on an ethylene-propylene co- or terpolymer backbone having a Mn of greater than 80,000. As one feature of the process the polymer is heated and mechanically sheared, e.g., in an extruder, to reduce its Mn to 5,500 to 50,000.

There is a continuing need to develop new methods and products for use as V.I. improving additives, including both viscosity index improver additives and multifunctional viscosity index improver additives, which, when incorporated into oleaginous compositions such as lubricating oil compositions, result in improved viscometric properties.

### SUMMARY OF THE INVENTION

Oil soluble viscosity index improver composition comprising a mixture of: (A) at least one molecular weight degraded copolymer of ethylene and at least one other alpha-olefin monomer; and (B) at least one substantially undegraded copolymer of ethylene and at least one other alpha-olefin monomer. The mixture is useful as a viscosity modifier for oleaginous compositions such as lubricating oil compositions and fuel compositions. Another aspect of the present invention is directed to the above oil soluble mixtures grafted with various grafting materials and optionally reacted with, e.g., polyamines or polyols, that are useful as viscosity index improvers and/or multifunctional viscosity index improvers in oleaginous compositions.

### DETAILED DESCRIPTION

In accordance with one aspect of the instant invention there are provided polymeric materials useful as V.I. improvers for oleaginous compositions, particularly lubricating oils, which are comprised of ethylene-alpha-olefin copolymers that have been, in part, degraded in order to reduce and/or modify, e.g., lower, the molecular weight, shear stability index (defined below) and/or other properties or characteristics.

The undegraded polymeric materials that are used in the mixture in undegraded form and that are also used as the starting materials which are subjected to degradation are comprised of a copolymer of ethylene and at least one other alpha-olefin monomer and optionally containing a minor amount of a nonconjugated polyene (in which case it is sometimes referred to as a terpolymer; for convenience, the term “copolymer” generally will be used throughout, but it is to be understood to include both copolymers and terpolymers of ethylene with at least one other alpha-olefin). The copolymer or terpolymer can be substantially amorphous or can be partially crystalline. Amorphous and crystalline properties and methods for measuring these properties are further defined below. Methods of producing useful copolymers and terpolymers are well known in the art and comprise various polymerization processes (e.g., including batch, continuous, stirred tank, and tubular reactors) as well as the use of various catalyst systems (e.g., including Ziegler-Natta, metallocene, constrained geometry and diimine). These various processes and catalyst systems are summarized below including identification of references describing each of the processes in detail.

The following terms are also defined for purposes of the present invention:

a. “Inter-CD (inter-compositional distribution)” defines the compositional variation (or dispersity) in ethylene content among polymer chains. It can be characterized as the difference in composition between copolymer fractions containing the highest and lowest quantities of ethylene. It is expressed as the minimum deviation (analogous to a standard deviation), in terms of weight percent ethylene, from the average ethylene composition for a given copolymer sample needed to include a given weight percent of the total copolymer sample, which is obtained by excluding equal weight fractions from both ends of the distribution. The deviation need not be symmetrical. When expressed as a single number, for example 15% Inter-CD, it shall mean the larger of the positive or negative deviations. For example, for a Gaussian compositional distribution, 95.5% of the polymer is within 20 wt. % ethylene of the mean if the standard deviation is 10%. The Inter-CD for 95.5 wt. % of the polymer is 20 wt. % ethylene for such a sample. Techniques for measuring the breadth of the Inter-CD are known as illustrated in “Polymerization of ethylene and propylene to amorphous copolymers with catalysts of vanadium oxychloride and alkyl aluminum halides”; E. Junghanns, A. Gumboldt and G. Bier; Makromol. Chem., Vol. 58 (Dec. 12, 1962): 18-42, wherein a p-xylene/dimethylformamide solvent/non-solvent was used to fractionate copolymer into fractions of differing intermolecular composition. Other solvent/non-solvent systems can be used, such as hexane/2-propanol. The technique of solvent/non-solvent fractionation is based on the thermodynamics of phase separation. This technique is also described in “Polymer Fractionation”, M. Cantow editor, Academic 1967, p. 341 and in H. Inagaki, T. Tanaku, “Developments in Polymer Characterization”, 3, 1, (1982). These are incorporated herein by reference to the extent permitted. Generally, for non-crystalline copolymers of ethylene and propylene, molecular weight governs insolubility more than does composition in a solvent/non-solvent solution. Furthermore, high molecular weight polymer is less soluble in a given solvent mixture. Also, there is a systematic correlation of molecular weight with ethylene content for the polymers described herein. Since ethylene polymerizes much more rapidly than propylene, high ethylene containing copolymer also tends to be high in molecular weight unless measures are taken to intervene in the polymerization process. Additionally, chains rich in ethylene tend to be less soluble in hydrocarbon/polar non-solvent mixtures than propylene-rich chains and also tend to be more crystalline. Finally, the solubility of crystalline segments, is significantly reduced. Thus, high molecular weight, high ethylene chains are easily separated on the basis of thermodynamics.

b. “Intra-CD” is the compositional variation (or dispersity), in terms of ethylene, within a copolymer chain. It is expressed as the minimum difference in weight (wt.) % ethylene that exists between two portions of a single copolymer chain, each portion comprising at least 5 weight % of the chain. The experimental procedure for determining Intra-CD is as follows. First the Inter-CD is established (as described above), then the polymer chain is broken into fragments along its contour (a suitable method for doing this is by thermal degradation wherein, e.g., a copolymer having an intial molecular weight of about 10⁵ is broken into fragments of about 5000 molecular weight) and the Inter-CD of the fragments is determined. The difference in the two results is due to Intra-CD.

c. “Molecular weight distribution (MWD)” is a measure of the range of molecular weights within a given copolymer sample. It is characterized in terms of at least one of the ratios of weight-average to number-average molecular weight, Mw/Mn, and z-average to weight-average molecular weight, Mz/Mw, where:

$$\begin{matrix}Mw = \frac{\sum {N}_{i} {M}_{i}^{2}}{\sum {N}_{i} {M}_{i}} \\ Mn = \frac{\sum {N}_{i} {M}_{i}}{\sum {N}_{i}} \\ Mz = \frac{\sum {N}_{i} {M}_{i}^{3}}{\sum {N}_{i} {M}_{i}^{2}}\end{matrix}$$

wherein Nᵢ is the number of molecules of molecular weight Mᵢ.

d. “viscosity Index (V.I.)” is the ability of a lubricating oil to accommodate increases in temperature with a minimum decrease in viscosity; the greater this ability, the higher the V.I. In the field of lubrication and lubricating compositions, V.I. is typically measured according to ASTM D2270.

e. “Shear Stability Index (SSI)” measures the mechanical stability of polymers used as V.I. improvers in crankcase lubricants subjected to high strain rates. SSI is indicative of the resistance of a polymer to molecular weight degradation by shearing forces. The higher the SSI the less stable the polymer, i.e., the more susceptible it is to molecular weight degradation. To determine SSI, the polymer under test is dissolved in a suitable base oil (for example, solvent extracted 150 neutral) to a relative viscosity of 2 to 3 at 100° C. For purposes of the present invention, shear stability index was measured according to ASTM D6278, and is defined as follows:

$$SSI = 100 \times \frac{{kv}_{before shear} - {kv}_{after shear}}{{kv}_{before shear} - {kv}_{oil}}$$

wherein kv_{before} shear is the kinematic viscosity of the polymer-reference oil solution before shear and kv_{after} shear is the kinematic viscosity of the polymer-reference oil solution after shearing.

f. “Thickening Efficiency (TE)” is defined as:

$$TE = \frac{2}{c ln 2} ln ( \frac{{kv}_{oil + polymer}}{{kv}_{oil}} )$$

wherein c is polymer concentration (gram polymer/100 grams solution), kv_{oil+polyer} is kinematic viscosity of the polymer in the reference oil, and kvₒᵢₗ is kinematic viscosity of the reference oil.

g. “Cold Cranking Simulator (CCS)” performance is another test conducted at low temperature and is a high shear and is determined using a technique described in ASTM D5293 or SAE J300 Appendix; viscosity results are reported in centipoise. This test is related to a lubricating oil's resistance to cold engine starting. The higher the CCS value the greater the oil's resistance to cold engine starting.

h. “Mini Rotary Viscometer (MRV)/TP-1” measures low temperature performance (e.g., at −250 and/or −35° C.) using the test method described in ASTM-D4684; viscosity results are reported in centipoise (cp). The TP-1 test is essentially the same as the MRV test except that a slow cooling cycle is used. The cycle is defined in SAE Paper No. 850443, K. O. Henderson et al. During the test, the temperature is gradually lowered to the test temperature, and then at that temperature the yield stress (YS) is measured in pascals, and the apparent viscosity (VIS) is measured in pascal seconds, or centipoise. MRV, CCS and TP-1 are all indicative of the low temperature viscometric properties of oil compositions.

i. “Pour point” measures the ability of an oil composition to flow as the temperature is lowered. Performance is reported in degrees centigrade and is measured using the test procedure described in ASTM D97. It, too, is a measure of an oil's low temperature performance.

j. “Crystallinity” in ethylene-alpha-olefin polymers can be measured using X-ray techniques known in the art as well as by the use of a differential scanning calorimetry (DSC) test. DSC can be used to measure crystallinity as follows: a polymer sample is annealed at room temperature (e.g., 20-25° C.) for at least 24 hours before the measurement. Thereafter, the sample is first cooled to −100° C. from room temperature, and then heated to 150° C. at 10° C./min. Crystallinity is calculated as follows:

$$\% Crystallinity = ( \sum Δ H ) \times {x}_{methylene} \times \frac{14}{4110} \times 100 \% ,$$

wherein ΣΔH (J/g) is the sum of the heat absorbed by the polymer above its glass transition temperature, x_{methylene} is the molar fraction of ethylene in the polymer calculated, e.g., from proton NMR data, 14 (g/mol) is the molar mass of a methylene unit, and 4110 (J/mol) is the heat of fusion for a single crystal of polyethylene at equilibrium.

For purposes of the present invention, an amorphous or substantially amorphous ethylene-alpha-olefin copolymer is defined as one having a degree of crystallinity, as measured for example by DSC, of from about zero to less than about 2.5%; preferably from about zero to about 2%; more preferably from about zero to about 1.5%. Conversely, a partially or semi-crystalline ethylene-alpha-olefin copolymer is one having a degree of crystallinity of greater than about 2.5%; preferably from greater than about 2.5% to about 25%; more preferably from about 3% to about 20%; still more preferably from about 3.5% to about 25%.

k. The term “about” when used as a modifier for, or in conjunction with, the size of a variable is intended to convey that the numbers and ranges disclosed are flexible and that practice of the present invention by those skilled in the art using temperatures, concentrations, amounts, contents, carbon numbers, properties such as molecular weight and viscosity, etc., that are outside of the range or different from a single value will achieve the desired result, namely oil soluble viscosity index improver compositions comprising a mixture of at least one molecular weight degraded ethylene alpha-olefin copolymer and at least one substantially undegraded ethylene alpha-olefin copolymer. If not otherwise stated, the term “about” typically includes a range of +10% for the value that it modifies. Furthermore, where a range of values is expressed, it is to be understood, unless otherwise expressed, that the present invention contemplates the use of other ranges that are subsumed within the broadest range.

Ethylene-Alpha-Olefin Copolymer

The undegraded ethylene-α-olefin copolymers that are used directly (i.e., as polymerized) and also degraded in order to prepare the mixtures of the instant invention useful as viscosity index improver additives are copolymers synthesized from ethylene monomer with at least one other alpha-olefin monomer. Certain copolymer features are common to copolymers useful in the present invention regardless of the process or catalyst used for their production. In particular, copolymers useful in the present invention have the following properties in common:

The average ethylene content of copolymers useful in the present invention can be as low as about 20% on a weight basis; preferably about 25%; more preferably about 30%. The maximum ethylene content can be about 90% on a weight basis; preferably about 85%; most preferably about 80%. The copolymers of this invention intended for use as viscosity modifiers typically comprise from about 35 to 75 wt. % ethylene; more preferably from about 40 to 73 wt. % ethylene. Ethylene-alpha-olefin copolymers useful in the present invention that are partially crystalline tend to have higher ethylene content than those that are characterized as amorphous or substantially amorphous. For example, partially crystalline ethylene-alpha-olefin copolymers comprise from greater than about 60 to about 90 wt. % ethylene; preferably from about 60 to about 88 wt. % ethylene; more preferably from about 65 to about 85 wt. % ethylene. Conversely, amorphous or substantially amorphous ethylene-alpha-olefin copolymers typically comprise from about 25 to about 60 wt. % ethylene; preferably from about 30 to about 60 wt. % ethylene; more preferably from about 35 to about 60 wt. % ethylene. Ethylene content can be measured by ASTM-D3900 for ethylene-propylene copolymers between 35 wt. % and 85 wt. % ethylene. Above 85 wt. %, ASTM-D2238 can be used to obtain methyl group concentration which is related to percent ethylene in an unambiguous manner for ethylene-propylene copolymers. When comonomers other than propylene are employed, no ASTM tests covering a wide range of ethylene contents are available; however, proton and carbon-13 nuclear magnetic resonance spectroscopy can be employed to determine the composition of such polymers. These are absolute techniques requiring no calibration when operated such that all nucleii of a given element contribute equally to the spectra. For ethylene content ranges not covered by the ASTM tests for ethylene-propylene copolymers, as well as for any ethylene-propylene copolymers, these nuclear magnetic resonance methods can also be used.

The copolymers in accordance with the present invention are comprised of ethylene and at least one other alpha-olefin. Such other alpha-olefins include those containing 3 to 18 carbon atoms, e.g., propylene, butene-1, pentene-1, etc. Alpha-olefins having 3 to 6 carbon atoms are preferred, particularly for economic reasons. The most preferred copolymers in accordance with the present invention are those comprised of ethylene and propylene. As is well known to those skilled in the art, copolymers of ethylene and higher alpha-olefins such as propylene can optionally include other polymerizable monomers. Typical of these other monomers are non-conjugated dienes such as the following non-limiting examples:

a. straight chain acyclic dienes such as: 1,4-hexadiene; 1,6-octadiene;

b. branched chain acyclic dienes such as: 5-methyl-1, 4-hexadiene; 3, 7-dimethyl-1,6-octadiene; 3, 7-dimethyl-1,7-octadiene and the mixed isomers of dihydro-mycene and dihydroocinene;

c. single ring alicyclic dienes such as: 1, 4-cyclohexadiene; 1,5-cyclooctadiene; and 1,5-cyclododecadiene; and

d. multi-ring alicyclic fused and bridged ring dienes such as: tetrahydroindene; methyltetrahydroindene; dicyclopentadiene; bicyclo-(2,2,1)-hepta-2, 5-diene; alkenyl, alkylidene, cycloalkenyl and cycloalkylidene norbornenes such as 5-methylene-2-norbornene (MNB), 5-ethylidene-2-norbornene (ENB), 5-propylene-2-norbornene, 5-isopropylidene-2-norbornene, 5-(4-cyclopentenyl)-2-norbornene; 5-cyclohexylidene-2-norbornene.

Of the non-conjugated dienes typically used to prepare these copolymers, dienes containing at least one of the double bonds in a strained ring are preferred. The most preferred diene is 5-ethylidene-2-norbornene (ENB). When present, the amount of diene (on a weight basis) in the copolymer can be from greater than 0% to about 20%; preferably from greater than 0% to about 15%; most preferably greater than 0% to about 10%.

The molecular weight of copolymers useful in accordance with the present invention can vary over a wide range since ethylene copolymers having number-average molecular weights as low as about 2,000 can affect the viscosity properties of an oleaginous composition. The preferred minimum Mn is about 10,000; the most preferred minimum is about 20,000. The maximum Mn can be as high as about 12,000,000; the preferred maximum is about 1,000,000; the most preferred maximum is about 750,000. An especially preferred range of number-average molecular weight for copolymers useful in the present invention as viscosity modifiers is from about 25,000 to about 500,000. Generally, copolymers useful as viscosity index improvers are those having number average molecular weights, Mn, of from about 15,000 to about 250,000; preferably from about 20,000 to about 150,000. It is known that copolymers at the lower end of the molecular weight range can difficult to process, isolate and handle, or are relatively more expensive to produce than the higher molecular weight versions. Additionally, it may be difficult or expensive to directly polymerize copolymers having the specific performance characteristics, particularly, the desired SSI. Therefore, in accordance with the present invention, it is generally easier, more economical and hence preferred to form higher molecular weight copolymers, for example those having number average molecular weights of from about 25,000 to about 500,000 (and typically also exhibiting higher values of SSI), and then to degrade such copolymers to the desired molecular weight and SSI for blending with an undegraded copolymer in order to obtain the final, target properties. Such a blending process allows one to advantageously achieve a balance of economy and performance targets.

Molecular weight and molecular weight distribution can be measured by techniques well known in the art. For example, one method uses a Waters 150 C gel permeation chromatograph equipped with a Chromatix KMX-6 (LDC-Milton Roy, Riviera Beach, Fla.) on-line light scattering photometer. The system can usefully be operated at 135° C. with 1,2,4 trichlorobenzene as the mobile phase. Showdex (Showa-Denko America, Inc.) polystyrene gel columns 802, 803, 804 and 805 are conveniently used. This technique is discussed in “Liquid Chromatography of Polymers and Related Materials III”, J. Cazes editor, Marcel Dekker, 1981, p. 207 (incorporated herein by reference to the extent permitted). Typically, no corrections for column spreading are needed since data on generally accepted standards, e.g., National Bureau of Standards Polyethene 1484 and anionically produced hydrogenated polyisoprene (an alternating ethylene-propylene copolymer) demonstrate that such corrections of Mw/Mn or Mz/Mw are less than 0.05 unit. Mw/Mn is calculated from an elution time-molecular weight relationship whereas Mz/Mw is determined using the light scattering photometer. Light scattering and refractive index detectors are particularly useful for determining Mw and Mw/Mn, respectively. The numerical analyses can be performed using a commercially available computer software program, GPC2, MOLWT2 available from LDC/Milton Roy-Riviera Beach, Fla. The methods for determining such molecular characteristics are now well-known in the polymer art.

The copolymers useful in this invention are also generally characterized by a thickening efficiency (T.E.) of from about 0.4 to 5.0, preferably from about 1.0 to 4.2, most preferably from about 1.4 to 3.9.

Tubular Reactor or Tubular Process Copolymers

Copolymers of ethylene and at least one other alpha-olefin monomer synthesized in a tubular reactor are comprised of segmented copolymer chains that are intramolecularly heterogeneous and intermolecularly homogeneous. The copolymers and their method of manufacture are described in detail U.S. Pat. No. 4,804,794, the disclosure of which is incorporated herein by reference to the extent permitted.

For tubular copolymers, at least one segment of each copolymer chain, constituting at least 10% of the chain, is a crystallizable segment. For the purpose of this application, the term “crystallizable segment” is defined to be each segment of the copolymer chain having a number-average molecular weight of at least 700 wherein the ethylene content is at least 57 wt. %. The remaining segments of the copolymer chain are herein termed the “low crystallinity segments” and are characterized by an average ethylene content of not greater than about 53 wt. % and wherein at least two portions of an individual intramolecularly heterogeneous chain, each portion comprising at least 5 weight percent of said chain, differ in composition from one another by at least 7 weight percent ethylene. Furthermore, the molecular weight distribution (MWD) is characterized by the ratios of various molecular weight averages. For example, an indication of a narrow MWD in accordance with the present invention is that the ratio of weight to number-average molecular weight (Mw/Mn) is less than about 2. Alternatively, a ratio of the z-average molecular weigh to the weight-average molecular weight (Mz/Mw) of less than about 1.8 typifies a narrow MWD in accordance with the present invention. Copolymers useful as starting point materials for use in mixtures in accordance with the present invention are characterized by having at least one of Mw/Mn less than about 2 and Mz/Mw less than about 1.8. The copolymer comprises chains within which the ratio of the monomers varies along the chain length. To obtain the intramolecular compositional heterogeneity and narrow MWD, the copolymers are preferably made in a tubular reactor and such copolymers are therefore referred to herein as “tubular”.

The low crystallinity segment of the copolymer is characterized in the unoriented bulk state after at least 24 hours annealing by a degree of crystallinity of less than about 0.2% at 23° C. The crystallizable segments comprise from about 10 to 90 wt. %, preferably from about 20 to 85 wt. %, of the total copolymer chain, and contain an average ethylene content which is at least about 57 wt. %, preferably at least about 62 wt. %, and more preferably at least about 63 wt. % and which is not greater than 95 wt. %, more preferably less than 85%, and most preferably less than 75 wt. % (e.g., from about 58 to 68 wt. %). The low crystallinity copolymer segments comprise from about 90 to 10 wt. %, preferably from about 80 to 15 wt. %, and more preferably from about 65 to 35 wt. %, of the total copolymer chain, and contain an average ethylene content of from about 20 to 53 wt. %, preferably from about 30 to 50 wt. %, and more preferably from about 35 to 50 wt. %. The copolymers comprise intramolecularly heterogeneous chain segments wherein at least two portions of an individual intramolecularly heterogeneous chain, each portion comprising at least 5 weight percent of the chain and having a molecular weight of at least 7000, contain at least 5 wt. % ethylene and differ in composition from one another by at least 5 weight percent ethylene, wherein the intramolecular compositional dispersity of the polymer is such that 95 wt. % of the polymer chains have a composition 15% or less different in ethylene from the average weight percent ethylene composition, and wherein the copolymer is characterized by at least one of a ratio of Mw/Mn of from about 1 to less than 2 and a ratio of Mz/Mw of from about 1 to less than 1.8.

The tubular copolymers preferably contain at least one crystallizable segment rich in methylene units (hereinafter called an “M” segment) and at least one low crystallinity ethylene-alpha-olefin copolymer segment (hereinafter called a “T” segment). The copolymers may be therefore illustrated by copolymers selected from the group consisting of copolymer chain structures having the following segment sequences:

M-T (I)

T¹-(M-T²)ₓ (II) and

T¹-(M¹-T²)_{y}-M² (III)

wherein M and T are defined above, M¹ and M² can be the same or different and are each M segments, T¹ and T² can be the same or different and are each T segments, x is an integer of from 1 to 3 and y is an integer of from 1 to 3. Preferably, the copolymer will contain only one M segment per chain. Therefore, structures I and II (x=1) are preferred. In a preferred embodiment, the M segment is located near the center of the copolymer chain and only one M segment is in the chain. The M segments of the copolymers comprise ethylene and can also comprise at least one other alpha-olefin, e.g., containing 3 to 18 carbon atoms. The T segments comprise ethylene and at least one other alpha-olefin, e.g., alpha-olefins containing 3 to 18 carbon atoms. The M and T segments can also comprise other polymerizable monomers, e.g., non-conjugated dienes or cyclic mono-olefins.

The Inter-CD of copolymers useful in the present invention and produced in a tubular reactor process is such that 95 wt. % of the copolymer chains have an ethylene composition that differs from the average weight percent ethylene composition by 15 wt. % or less; preferably about 13% or less; most preferably about 10% or less. The Intra-CD of tubular copolymers useful in the present invention is such that at least two portions of an individual intramolecularly heterogeneous chain, each portion comprising at least 5 weight percent of the chain, differ in composition from one another by at least 7 weight percent ethylene. Unless otherwise indicated, this property of Intra-CD as referred to herein is based upon at least two 5 weight percent portions of copolymer chain. Alternatively, the Intra-CD of copolymer can be such that at least two portions of copolymer chain differ by at least 10 weight percent ethylene; differences of at least 20 weight percent, as well as, of at least 40 weight percent ethylene are also considered to be in accordance with the present invention.

Tubular copolymers useful in the present invention are characterized by a MWD that is very narrow, as characterized by at least one of a ratio of Mw/Mn of from about 1 to less than 2 and a ratio Mz/Mw of from about 1 to less than 1.8. Preferred copolymers have Mw/Mn less than about 1.5, with less than about 1.25 being most preferred. The preferred Mz/Mw is greater than about 1 and less than about 1.5, with less than about 1.2 being most preferred.

Copolymers useful in the instant invention are produced by polymerization of a reaction mixture comprising catalyst, ethylene and at least one additional alpha-olefin monomer (and optionally a nonconjugated diene comonomer). In the tubular process the amounts of monomer, and preferably ethylene, are varied during the course of the polymerization in a controlled manner in order to obtain the desired overall compositional features. Process details can also be found in U.S. Pat. No. 4,804,794. Solution polymerization is preferred for each of the processes described herein and the nature of the solvent is determined, in part, by the catalyst system employed. Any known solvent for the reaction mixture that is effective for the purpose can be used in conducting tubular solution polymerizations as described in the art. For example, suitable solvents are hydrocarbon solvents such as aliphatic, cycloaliphatic and aromatic hydrocarbon solvents, or halogenated versions of such solvents.

Tubular polymerizations are carried out in a mix-free reactor system, which is one in which substantially no mixing occurs between portions of the reaction mixture that contain polymer chains initiated at different times. It is preferred to use continuous flow tubular reactors. A tubular reactor is well known and is designed to minimize mixing of the reactants in the direction of flow. As a result, reactant concentration will vary along the reactor length. Use is preferably made of at least one tubular reactor, but a series of tubular reactors could be used with multiple monomer feed to vary intramolecular composition.

The tubular polymerization process should be conducted such that: (a) the catalyst system produces essentially one active catalyst species; (b) the reaction mixture is essentially free of chain transfer agents; and (c) the polymer chains are essentially all initiated simultaneously, which is at the same time for a batch reactor or at the same point along the length of the tube for a tubular reactor. optionally, additional solvent and reactants (e.g., at least one of the ethylene, alpha-olefin and diene) will be added along the length of a tubular reactor in a controlled manner. However, it is necessary to add essentially all of the catalyst at the inlet of the tube to meet the requirement that essentially all polymer chains are initiated simultaneously. Accordingly, polymerizations in accordance with the present invention are carried out: (a) in at least one mix-free reactor; (b) using a catalyst system that produces essentially one active catalyst species; (c) using at least one reaction mixture which is essentially transfer agent-free; and (d) in such a manner and under conditions sufficient to initiate propagation of essentially all polymer chains simultaneously.

The composition of the catalyst used to produce alpha-olefin copolymers has a profound effect on copolymer product properties such as compositional dispersity and MWD. As stated, the catalyst utilized in practicing tubular processes should be such as to yield essentially one active catalyst species in the reaction mixture. Ziegler catalyst systems useful in the tubular process are described in detail hereinbelow in the section entitled “Ziegler-Natta Catalyst/Process” and preferably comprise a vanadium-based catalyst system. However, catalyst systems useful in the tubular process more specifically, should yield one primary active catalyst species that provides for substantially all of the polymerization reaction. Additional active catalyst species could provide as much as 35% (weight) of the total copolymer; preferably, they should account for about 10% or less of the copolymer. Techniques for characterizing catalyst according to the number of active catalyst species are described in an article entitled “Ethylene-Propylene Copolymers. Reactivity Ratios, Evaluation and Significance”, C. Cozewith and G. Ver Strate, Macromolecules, 4, 482 (1971), incorporated herein by reference to the extent permitted. Catalyst deactivation during the course of the polymerization leads to termination of growing chains resulting in a broadening of molecular weight distribution and Inter-CD. It is well known that the vanadium-based Ziegler catalysts are subject to such deactivation reactions which depend to an extent upon the composition of the catalyst. Generally, deactivation can be reduced by using the shortest residence time and lowest temperature in the reactor that will produce the desired monomer conversions. If desired, catalyst activators for the selected vanadium catalysts can be used as long as they do not cause the criteria for a mix-free reactor to be violated, typically in amounts up to 20 mol %, generally up to 5 mol %, based on the vanadium catalyst, e.g., butyl perchlorocrotonate, benzoyl chloride, and other activators disclosed in U.S. Pat. No. 4,808,387 and U.S. Pat. No. 4,871,523, the disclosures of which are hereby incorporated by reference to the extent permitted. Other useful catalyst activators are described below in the section “Ziegler-Natta Catalyst/Process”.

Conducting polymerizations to initiate propagation of essentially all copolymer chains simultaneously can be accomplished by utilizing the process steps and conditions described in detail in U.S. Pat. No. 4,804,794. Briefly stated, the process includes steps to control premixing time and temperature of the catalyst and cocatalyst, polymerization temperature and temperature control, flow rate of the polymerization reaction mass through the tubular reactor, control of radial mixing and polymerization residence time.

By practicing the tubular process in accordance with the teachings of the art as noted, ethylene-alpha-olefin copolymers useful as starting point components for preparing the mixtures claimed herein and having very narrow MWD can be made by direct polymerization. Although narrow MWD copolymers can be made using other known techniques, such as by fractionation or mechanical degradation. EPM and EPDM made in the tubular process have good shear stability and are capable of exhibiting excellent low temperature properties. It is preferred that the Intra-CD of these copolymers is such that at least two portions of an individual intramolecularly heterogeneous chain, each portion comprising at least 5 wt. % of said chain, differ in composition from one another by at least 5 wt. % ethylene. The Intra-CD can be such that at least two portions of copolymer chain differ by at least 10 wt. % ethylene. Differences of at least 20 wt. %, as well as, 40 wt. % ethylene are also useful in the present invention. It is also preferred that the Inter-CD of the copolymer is such that 95 wt. % of the copolymer chains have an ethylene composition that differs from the copolymer average weight percent ethylene composition by 15 wt. % or less. The preferred Inter-CD is about 13% or less, with the most preferred being about 10% or less.

Ziegler-Natta Catalyst/Process

Ziegler-Natta polymerization processes are well known to those skilled in the art and numerous patent and journal references are available that provide details for the production of ethylene alpha-olefin copolymers that are substantially amorphous or that contain varying degrees of crystallinity. As described in GB 1,397,994, incorporated herein by reference to the extent permitted, it is disclosed that the synthesis of higher molecular weight copolymers of ethylene and a higher alpha-olefin such as propylene is carried out using soluble Ziegler-Natta catalyst compositions described herein and well known in the art and that such copolymers can be prepared in batch or continuous reactor systems. Additionally, U.S. Pat. No. 4,113,636, also incorporated herein by reference to the extent permitted, describes modified ethylene alpha-olefin copolymers for use in oil compositions. The copolymers have a degree of crystallinity of from about 3 to about 25 weight percent and are used as starting materials in a polymer degradation process and are subsequently grafted with a polyethylene amine.

For the purposes of the present invention, reference to a Ziegler-Natta catalyst system or process means a process other than a tubular process (although, as described above, Ziegler-Natta catalysts are also useful in that process as well as a batch polymerization process). In the present context, reference to Ziegler-Natta, unless otherwise stated, is understood to mean a polymerization process conducted in a continuous flow stirred tank reactor (CFSTR). In the Ziegler-Natta process as presently defined, incoming feed to the CSTR is blended with the polymerizing reaction mixture to produce a solution of essentially uniform composition everywhere in the reactor. Consequently, the growing chains in various portions of the reaction mixture will vary in age.

The process and catalyst systems broadly denoted as Ziegler-Natta (sometimes also referred to herein as a Ziegler catalyst system) and useful for producing copolymers useful in accordance with the present invention are not limited to those resulting in only one active catalyst species, although such catalyst systems are preferred. Ziegler-Natta catalyst systems useful in producing copolymers for use in the present invention include:

(a) a compound of a transition metal, i.e., a metal of Groups I-B, III-B, IVB, VB, VIB, VIIB and VIII of the Periodic Table of the Elements; and

(b) an organometallic compound of a metal of Groups I-A, II-A, II-B and III-A of the Periodic Table.

The preferred catalyst system comprises hydrocarbon-soluble vanadium compound in which the vanadium valence is 3 to 5 and an organo-aluminum compound, with the proviso that the catalyst yields essentially one active catalyst species as described above. At least one of the vanadium compound/organo-aluminum pair selected must also contain a valence-bonded halogen.

Nonlimiting illustrative examples of useful compounds are vanadyl trihalides, alkoxy halides and alkoxides such as VOCl₃, VOCl₂ (OBu) where Bu=butyl, and VO(OC₂H₅)₃. The most preferred vanadium compounds are VCl₄, VOCl₃, and VOCl₂(OR), wherein R is a hydrocarbon radical. The co-catalyst is preferably at least one organo-aluminum compound. The most preferred organo-aluminum compound is an aluminum alkyl sesquichloride such as Al₂Et₃Cl₃ or Al₂(iBu)₃Cl₃. In terms of performance, a catalyst system comprising VCl₄ and Al₂R₃Cl₃, preferably where R is ethyl, is particularly effective. For best catalyst performance, the molar amounts of catalyst components added to the reaction mixture should provide a molar ratio of aluminum/vanadium (Al/V) of at least about 2. The preferred minimum Al/V is about 4. The maximum Al/V is based primarily on the considerations of catalyst expense and the desire to minimize the amount of chain transfer that may be caused by the organo-aluminum compound. Since, as is known certain organo-aluminum compounds act as chain transfer agents, if too much is present in the reaction mixture the Mw/Mn of the copolymer may rise above 2. Based on these considerations, the maximum Al/V could be about 32, however, a maximum of about 17 is more preferred. The most preferred maximum is about 15. Certain combinations of vanadium and aluminum compounds comprising the catalyst system can cause branching and gelation during the polymerization of polymers containing high levels of diene. To prevent this from happening, Lewis bases such as ammonia, tetrahydrofuran, pyridine, tributylamine, tetrahydrothiophene, etc., can be added to the polymerization system using techniques known to those skilled in the art.

For the essentially single active species of Ziegler catalyst systems identified above, addition of chain transfer agents to a CFSTR reduces the polymer molecular weight, but does not affect the molecular weight distribution. Chain transfer agents for the Ziegler-catalyzed polymerization of alpha-olefins are well known and are illustrated, by way of example, by hydrogen or diethyl zinc for the production of EPM and EPDM. Such agents are commonly used to control the molecular weight of EPM and EPDM produced in continuous flow stirred reactors. Although difficult to generalize for all polymerization conditions, the amount of chain transfer agent used should be limited to those amounts that provide copolymer product in accordance with the desired Mn or Mw limits and consistent with the target MWD and compositional dispersity. The maximum amount of chain transfer agent present in the reaction mixture can be as high as about 0.2 mol/mol of transition metal, e.g., vanadium.

If desired, catalyst activators for the selected vanadium catalysts can be used. When present, catalyst activators are typically used in amounts up to 20 mol %, generally up to 5 mol %, for example based on the vanadium catalyst; activators included are those such as butyl perchlorocrotonate, benzoyl chloride, and other activators disclosed in U.S. Pat. No. 4,808,387 and U.S. Pat. No. 4,871,523, the disclosures of which are hereby incorporated by reference to the extent permitted.

Suitable temperatures for conducting the polymerization range from about −50° C. to about 80° C.; preferably form about 0° C. to about 60° C.; most preferably from about 10° C. to about 50° C. Temperature is not a critical parameter and its choice will depend on the design and materials of construction of the equipment as well as other process variables including, in particular, the means employed for removing and controlling the heat of reaction and maintaining constant the temperature of polymerization. Polymerization pressure is not a critical variable provided that the pressure used is that sufficient to maintain the reactants in the liquid phase at the polymerization temperature, e.g., from about 60 to about 150 psig (about 517 to about 1138 kPa).

Ethylene alpha-olefin copolymers useful in the present invention and produced in a Ziegler-Natta process include those copolymers having an ethylene content as described above, e.g., in the range of from about 20 to about 90 percent on a weight basis; a degree of crystallinity of from about 1 to 25 wt. %, preferably about 3 to 18 wt. %, as determined by X-ray and differential thermal analyses, and Mn of from about 20,000 to 200,000, preferably 35,000 to 120,000. As noted in U.S. Pat. No. 4,113,636, particularly useful high ethylene content copolymers, e.g., those containing from about 68 to about 80 mole percent, preferably 70 to about 80 mole percent, are also capable of containing a moderate degree of crystallinity. A degree of crystallinity of from about 3 up to about 25 weight percent, for example from about 4 to about 12 weight percent can be prepared. The reference teaches that procedures available for determining crystallinity include X-ray and differential scanning calorimetry; see, e.g., J. Polymer Sci. A-2, 9, 127 (1971) by G. Verstrate and Z. W. Wilchinsky. The molecular weight distribution in useful copolymers, Mw/Mn as defined above, is generally greater than about 1 to about 8, preferably 6 or less. Generally, copolymers produced in a Ziegler-Natta process will have a molecular weight distribution that is somewhat broader than those produced in the tubular process or using metallocene or diimine catalyst systems.

Metallocene Catalyst/Process

Polyolefins, and ethylene alpha-olefin copolymers in particular, have been synthesized using a class of catalysts referred to in the art as “metallocene” catalyst systems; see, for example, U.S. Pat. No. 5,324,800, incorporated herein by reference to the extent permitted. These catalyst systems and processes using them are now well known to those skilled in the art of olefin polymerization. The metallocene catalyst system is a homogeneous catalyst system in contrast to the Ziegler-Natta system that typically is heterogeneous. Furthermore, metallocene catalyst systems tend to produce polymers and copolymers that have a high degree of terminal unsaturation, e.g., terminal vinylidene, compared with Ziegler-Natta systems.

The first component of the catalyst system disclosed in U.S. '800 cited above is an organometallic coordination compound or a bulky ligand transition metal compound selected from the group consisting of mono-, bi- or tricyclopentadienyl or substituted cyclopentadienyl metal compounds. The metal is selected from the group consisting of Group 4B, 5B, and 6B of the periodic table of the elements. In particular, zirconocenes and titanocenes are preferred; hafnocenes are also useful. These compounds are described in the reference in detail. The second component of a metallocene catalyst system is a cocatalyst or activator. The terms “cocatalyst or activator” are used interchangeably with regard to metallocene catalyst systems and are defined to include any compound or component which can activate the above-referenced bulky ligand transition metal compound. The traditional activators for a metallocene catalyst system typically include Lewis acids such as alumoxane compounds, and ionizing, anion pre-cursor compounds that cause abstraction of a portion of the bulky ligand transition metal compound so as to ionize the transition metal center into a cation and provide a counterbalancing, compatible, noncoordinating anion.

In one version of a metallocene catalyst system the metallocene component is used in combination with soluble polymeric aluminum compounds known as alumoxanes, represented by the formula for cyclic compounds (R-Al-O)n and for linear compounds, R(R—Al—O—)nAlR₂, wherein R is a C₁-C₅ alkyl group such as methyl, ethyl, propyl etc. and n is an integer from 1 to about 20. These compounds are generally prepared from aluminum trialkyl and water or a water source such as hydrated copper sulfate. When used as a component, the mole ratio of aluminum in the alumoxane to total metal in the metallocene can be in the range of from about 0.5:1 to about 1000:1; desirably about 1:1 to about 100:1; preferably about 50:1 to about 5:1; most preferably about 20:1 to about 5:1.

As noted above, other cocatalysts or activators useful in a metallocene catalyst system include compounds referred to as noncoordinating anions. The term “noncoordinating anion” as used for the ionizing, anion pre-cursor compounds is recognized to mean an anion which either does not coordinate to said transition metal cation or which is only weakly coordinated to said cation thereby remaining sufficiently labile to be displaced by a neutral Lewis base.

“Compatible” noncoordinating anions are those that are not degraded to neutrality when the initially formed complex between the late-transition-metal catalyst compounds and the ionizing, anion pre-cursor compounds decomposes. Further, the anion will not transfer an anionic substituent or fragment to the cation so as to cause it to form a neutral four coordinate metal compound and a neutral by-product from the anion. Noncoordinating anions useful in accordance with this invention are those which are compatible, stabilize the transition metal cation in the sense of balancing its ionic charge in a +1 state, yet retain sufficient lability to permit displacement by an olefinically unsaturated monomer during polymerization. Additionally, the anions useful in this invention will be large or bulky in the sense of sufficient molecular size to partially inhibit or help to prevent neutralization of the transition metal cation by Lewis bases other than the polymerizable monomers that may be present in the polymerization process. Descriptions of ionic catalysts, those comprising a transition metal cation (based on metallocenes) and a non-coordinating anion, suitable for coordination polymerization appear in U.S. Pat. Nos. 5,064,802, 5,132,380, 5,198,401, 5,278,119, 5,321,106, 5,347,024, 5,408,017, WO 92/00333 and WO 93/14132. These references teach a preferred method of preparation wherein metallocenes are protonated by an anion precursor such that an alkyl/hydride group is abstracted from a transition metal to make it both cationic and charge-balanced by the noncoordinating anion. Other activators and their methods of preparation and use in metallocene catalyst systems are disclosed in EP-A-426637, EP-A-573403, U.S. Pat. No. 5,387,568, EP-A-427697, EP-A-520732 and EP-A-495375. The description of non-coordinating anions and precursors thereto in the relevant portions of the preceding disclosures are incorporated herein by reference to the extent permitted.

As noted above, the catalyst system is homogeneous and the solvents used to prepare the catalysts are also those that are useful for conducting the polymerization, e.g., isobutene, butane, pentane, hexane, heptane, octane, cyclohexane, methylcyclohexane, toluene, xylene and the like. Alternatively, the polymerization can be conducted in the liquid monomer mixture. Also as noted above, metallocene polymerizations can be conducted at relatively high temperatures, e.g., from about 20° C. to about 300° C., preferably between about 30° C. and about 200° C. Olefin polymerizations, including ethylene copolymers, using a metallocene catalyst system can be conducted over a wide range of pressures, e.g., from about 10 bar to about 3,000 bar; generally from about 40 bar to about 2,000 bar; most preferably from about 50 bar to about 1,500 bar.

A metallocene catalyst system can be used in a batch polymerization process as is well known in the art, although for economic reasons a continuous process is preferred. Polymerization can be conducted in a continuous manner by simultaneously feeding the reaction diluent (if employed), monomers, catalyst and cocatalyst to a reactor and withdrawing solvent, unreacted monomer and polymer from the reactor so as to allow a residence time of ingredients long enough for forming copolymer of the desired molecular weight, and separating the polymer from the reaction mixture. After polymerization, the catalyst is deactivated and the product polymer is recovered by processes well known in the art. Deactivation of the catalyst is accomplished by conventional techniques such as contacting the polymerization reaction medium with water or an alcohol (such as methanol, propanol, isopropanol, etc.), or cooling or flashing the polymerization reaction mixture in order to terminate the polymerization reaction. Any excess reactants or diluents can be flashed off from the polymer.

The molecular weight of copolymers produced by metallocene catalyst systems can be controlled by the nature of the metallocene compound as well as the ratio of alumoxane to metallocene. The catalyst system allows for the production of high molecular weight copolymers in a relatively high temperature process, although reducing the temperature also tends to increase copolymer molecular weight. While hydrogen is useful for molecular weight control as with Ziegler-Natta catalysts, it is not necessary in view of the range of process and catalyst features available for such control (e.g., selection of the substituent on the cyclopentadienyl ring and use of ligands for the metallocenes). Furthermore, it is undesirable to use hydrogen for molecular weight control if it is an objective to maintain the terminal unsaturation of the polymer (e.g., for use as an active site for subsequent grafting or derivatization). In addition, comonomer content can be controlled by selection of the metallocene.

Metallocene catalyst systems are capable of producing ethylene alphaolefin copolymers over a broad range of molecular weights, having narrow molecular weight distributions and of varying composition; they are particularly well suited for producing ethylene copolymers useful as components for the mixtures of the present invention. Mw/Mn of the copolymers ranges from about 1.5 to about 4.0 and also include an average of about one chain end unsaturation per molecule, with the majority being terminal vinylidene. Minor amounts of other unsaturated species can also be present, e.g., ethenyl and internal monounsaturation. Metallocene copolymers useful as viscosity modifiers are described in U.S. Pat. No. 5,151,204, incorporated herein by reference to the extent permitted. This patent discloses that the metallocene copolymers comprise polymer chains, at least about 30 percent of which contain terminal ethenylidene (also called vinylidene) unsaturation; preferably at least about 60%; most preferably at least about 75% (e.g., 75-98%). The percentage of polymer chains exhibiting these unsaturated species can be determined by Fourier Transform Infrared (FTIR) spectroscopic analysis or by proton or ¹³C-NMR.

Constrained Geometry Catalyst/Process

Catalyst systems of this type and the copolymers produced therefrom that are useful as viscosity index improvers are described in published PCT application WO 97/32946, incorporated herein by reference to the extent permitted. These copolymers are also useful in the mixtures claimed herein and are referred to as “substantially linear ethylene polymers”, abbreviated as SLEP (the reference defines “substantially linear” as a polymer that has a backbone substituted with from 0.01 to 3 long-chain branches per 1000 carbons in the backbone).

SLEP copolymers are characterized as having a narrow molecular weight distribution, a narrow comonomer distribution and a controlled architecture:

(a) ethylene comonomer content typically is between 20 and 80 wt. %, preferably between 30 and 70 wt. %;

(b) melt properties, specifically, I₂ of 0.01-500 g/10 min; more preferably from 0.05-50 g/10 min (test method ASTM D1238, condition 190° C./2.16 kg);

(c) melt flow rate (MFR, as measured by ASTM D1238) of greater than 5.63, preferably form 6.5-15, more preferably from 7-10. Furthermore, the ratio I₁₀/I₂ for a SLEP polymer serves as an indication of the degree of long chain branching (LCB), such that the larger the ratio the higher the degree of LCB in the polymer. The term LCB is defined to mean a chain length of at least 6 carbon atoms (chain lengths of greater than 6 carbon atoms cannot be distinguished by 13C-NMR spectroscopy). In some instances a chain length can be as long as the polymer backbone to which it is attached. In addition, the MFR is essentially independent of Mw/Mn;

(d) Mw/Mn is less than (I₁₀/I₂)−4.63. It is desirably greater than 0 and less than 5, especially from 1.5 to 3.5, preferably from 1.7-3; and

(e) a critical shear rate at the onset of surface melt fracture of at least 50% greater than the critical shear rate at the onset of surface melt fracture of a linear olefin polymer that has a like I₂ and Mw/Mn.

SLEP copolymers are said to be commercially available under the trademark “ENGAGE” from DuPont Dow Elastomers L.L.C. They may be prepared as described in U.S. Pat. No. 5,272,236 (1236) and 5,278,272, (1272) incorporated herein by reference to the extent permitted. Production of SLEPs having desired properties is disclosed in '236 starting at column 5, line 67 through column 6, line 28 using a continuous controlled polymerization process in at least one reactor, but allowing for multiple reactors. Polymerization temperature and pressure can be varied to produce the desired product and is preferably conducted in solution at a temperature of from 20° C. to 250° C., using constrained geometry catalyst technology.

Suitable constrained geometry catalysts are disclosed starting at column 6, line 29 through column 13, line 50 of U.S. '236. These catalysts may be described as comprising a metal coordination complex that comprises a metal of groups 3-10 or the Lanthanide series of the Periodic Table of the Elements and a delocalized pi-bonded moiety substituted with a constraint-inducing moiety. The complex has a constrained geometry about the metal atom such that the angle at the metal between the centroid of the delocalized, substituted pi-bonded moiety and the center of at least one remaining substituent is less than such angle in a similar complex containing a similar pi-bonded moiety lacking in such constraint-inducing substituent. If such complexes comprise more than one delocalized, substituted pi-bonded moiety, only one such moiety for each metal atom of the complex is a cyclic, delocalized, substituted pi-bonded moiety. The catalyst further comprises an activating cocatalyst such as tris(pentafluorophenyl)borane. Specific catalyst complexes are disclosed in U.S. '236 at column 6, line 57 through column 8, line 58 and in U.S. '272 at column 7, line 48 through column 9, line 37.

The disclosure of WO 97/32946 also describes modification of SLEPs by grafting and derivatization. Such polymer modifications can be applied as well to the mixtures of the present invention in order to produce viscosity index improvers having dispersant as well as viscosity modifying properties.

Diimide Catalysts/Process

Catalyst systems of this type and ethylene alphaolefin copolymers produced therefrom that are useful as viscosity index improvers are disclosed in U.S. Pat. No. 5,866,663 (U.S. '663), U.S. Pat. No. 5,811,379 (U.S. '379) and WO 98/03617 (WO '617), the disclosures of which are incorporated herein by reference to the extent permitted. These catalyst systems are also sometimes referred to in U.S. '379 and WO '617 as late transition metal catalyst systems or as so-called transition metal coordination catalysts.

U.S. '663 comprehensively presents the technology relating to the preparation and use of the catalyst systems and copolymers produced using such catalyst systems. The catalyst system produces polyolefins having specifically defined branched structures, e.g., containing about 80 to 150 branches per 1000 methylene groups, and which for every 100 branches that are methyl, about 30 to about 90 ethyl branches, about 4 to about 20 propyl branches, about 15 to about 50 butyl branches, about 3 to about 15 amyl branches, and about 30 to about 140 hexyl or longer branches. Also disclosed are polyolefins containing 20 to 150 branches per 1000 methylene groups, and which for every 100 branches that are methyl, about 4 to about 20 ethyl branches, about 1 to about 12 propyl branches, about 1 to about 12 butyl branches, about 1 to about 10 amyl branches, and about 0 to about 20 hexyl or longer branches (in each instance, branching is determined by NMR spectroscopy as taught in the patent examples). In addition to relatively random copolymers, these catalyst systems are also capable of producing useful block copolymers as well as polymers having varying degrees of crystallinity. It is also disclosed that narrow molecular weight distribution polymers can be produced and that randomly branched olef in polymers have a molecular weight distribution from about 1.5 to about 2.5. The various copolymers produced by the catalysts (and processes) referred to in the references, including those based on polar monomers, can be useful as components in the mixtures taught herein.

Numerous catalyst and process variations are disclosed in U.S. '663. The catalyst is based on a transition metal complex of a bidentate ligand, in particular complexes of a diimine with these metals. The transition metal is selected from the group consisting of Ti, Zr, Sc, V, Cr, a rare earth metal, Fe, Co Ni or Pd; Ni and Pd are preferred. Another catalyst of this type is one in which the late transition metal-containing (e.g., Ni or Pd) catalyst component is present in a complex coordinated with a weakly coordinating anion (also referred to in the section above relating to metallocene catalyst systems as a “noncoordinating anion”). Certain weakly coordinating anions are defined in the patent as preferred, including tetrakis[3,5-bis(trifluoromethyl)phenyl]borate (referred to as BAF⁻ in the patent), PF₆⁻, BF₄⁻, and SbF₆⁻. With certain of the late transition metal-containing compounds there is also used a neutral Lewis acid compound such alumoxane, as described above.

It is disclosed that the polymerization can be conducted in the presence of aprotic organic liquids, e.g., alkanes cycloalkanes, selected halogenated hydrocarbons, and aromatic hydrocarbons; particularly useful liquids include hexane, toluene and benzene. The catalyst system, monomers and copolymer may be soluble or insoluble in the liquid and the nature of the liquid can affect the yield, microstructure, molecular weight, etc. of the polymer obtained.

Polymerizations using the particularly preferred catalyst systems are carried out at temperatures of about −100° C. to about +200° C., preferably about 0° C. to about 150° C., more preferably about 25° C. to about 100° C. When Ni-containing catalysts are used, higher temperature can increase branching and decrease molecular weight. Polymerization pressure is not a critical process variable and can range from about atmospheric pressure to about 275 MPa, but higher pressure tends to reduce branching, particularly in ethylene-containing polymers.

Degradation of the Ethylene-Alpha-Olefin Copolymer

The undegraded ethylene-alpha-olefin copolymers useful in accordance with the present invention are degraded to lower molecular weight copolymers by any of the conventional and well-known degradation or molecular weight reduction processes. By degradation or molecular weight reduction processes are meant processes that reduce the molecular weight of the ethylene-alpha-olefin copolymers of this invention such that the SSI of the copolymer is at least 3% lower; preferably at least 5% lower than prior to degradation (the lower values reflect the actual test measurements since the test results are expressed as percentages, e.g., if the original SSI of the copolymer was 50%, the value after molecular weight degradation would preferably be 45% or less). Conversely, “substantially undegraded” means that the SSI of a copolymer corresponds to its original, as-polymerized or as-purchased condition or that the copolymer has undergone sufficiently little processing, e.g., mixing, shearing, extrusion, etc., that its SSI is within the test error of the test for measuring the SSI value for the original copolymer. Included among these processes are mechanical degradation and thermal degradation. Mechanical degradation processes generally involve shear-assisted breakdown of the copolymer. They may be carried out in the presence of oxygen, such as with added oxygen, in an inert atmosphere, as well as in the substantial absence of oxygen, i.e., wherein oxygen is not added and oxygen present is adventitious, e.g., that which is trapped, dissolved or dispersed in the copolymer or other reactants (if any). When an outside source of oxygen is used, the gas can be supplied in any convenient manner and at any convenient flow rate. Normally, air or oxygen is provided at a sufficient rate so that the amount of air or oxygen available to react with the copolymer does not limit the rate of oxidation. Such processes can be conducted in the presence or absence of catalysts and/or accelerators. While generally in mechanical processes the copolymer is either in the solid or melt phase, such processes also may be conducted in the presence of solvent, preferably inert solvent, including, e.g., hydrocarbons, halogenated hydrocarbons and lubricating oils and base stocks in which the viscosity modifier may be sold or used.

Simultaneous blending and shearing of an amorphous and a partially crystalline ethylene alphaolefin copolymer in the absence of a solvent, preferably in an extruder, is described in U.S. Pat. No. 5,391,617, incorporated herein by reference to the extent permitted. While the reference fails to appreciated the benefit and advantages of preparing a mixture of one or more degraded ethylene alphaolefin copolymers with undegraded ethylene alphaolefin copolymers as described herein, it is useful for its description of degradation methods for such copolymers.

In mechanical degradation processes the degree of shear and heat utilized in the process and the length of time that the copolymers are subjected to heat and shear are those which are effective to degrade the copolymer, i.e., reduce the molecular weight of the copolymer to the desired molecular weight (e.g., Mn of about 15,000 to about 150,000), SSI and/or thickening efficiency (T.E.). It is to be understood that these properties are not necessarily independent and that in some instances the polymer will be degraded to a target value of a specific property, e.g., SSI. If catalysts are utilized the amount of catalyst employed is a catalytically effective amount, i.e., an amount effective to catalyze the degradation reaction.

Thermal degradation processes may be carried out in the presence of oxygen, i.e., thermal oxidative degradation, or under an inert atmosphere, i.e., in the substantial absence of oxygen. Such processes are generally, although not always, conducted on a composition comprising the copolymer and an inert solvent or diluent, thereby forming a solution or dispersion of the copolymer. Various catalysts and/or accelerators may also be used in thermal degradation processes. The thermal degradation processes are carried out at temperatures and for periods of time that are effective to degrade the copolymer, i.e., reduce the molecular weight of the copolymer to the desired molecular weights (i.e., Mn of from about 15,000 to about 150,000), SSI and thickening efficiency. If catalysts are utilized, the amount of catalyst employed is a catalytically effective amount, i.e., an amount effective to catalyze the degradation process.

One mechanical degradation process comprises the shear assisted oxidation or mechanical breakdown and oxidation of the copolymers in the presence of an oxygen-containing gas such as air in a mechanical mixer such as an extruder, masticator, Banbury mixer, rubber mill, or the like. Mechanical breakdown and oxidation of the copolymer may be done in a single piece of equipment, or it may be done in stages with increasing intensity of the degree of breakdown that takes place and the amount of oxygen incorporated in the polymer. It is preferred to operate in the absence of diluent, solvent or oil so that the polymer is readily exposed to air and the level of shear stress is not reduced. Useful equipment includes Banbury mixers and mills, e.g., rubber mills having adjustable gaps, which devices may be enclosed or jacketed and through which a heating medium may be passed such as superatmospheric stream or heated Dowtherm (brand of heat transfer fluid). When mastication or breakdown has reached the desired level, as determined by oxygen uptake, SSI level, molecular weight (or a molecular weight related property, e.g., Mooney viscosity) or reduction in thickening efficiency (T.E.), an oil may be added to the degraded polymer. Usually enough oil is added to provide a concentration of degraded polymer in the range of about 5 wt. % to 50 wt. % based on the weight of the total resulting solution. Useful temperatures for carrying out mechanical degradation of the copolymers in the presence of oxygen range from about 120° C. to about 400° C. The time required to achieve satisfactory results will depend on the type of degrading or masticating equipment, the process temperature, and the speed of rotation if using a blade or rotor mixer as the degrading or masticating device (i.e., the work input). For example, a Bramley Beken Blade Mixer can be used to provide, in a single piece of equipment, the desired degree of mastication, or mixing and oxidative degradation. This mixer, which is equipped with a variable speed drive, has two rollers, fitted with helically disposed knives geared so that one roller revolves at one-half the speed of the other. The rollers are journalled in a jacketed reactor having two hemispherical halves in its base, which conform to the radii of the two rollers. A heating medium, such as described above, may be circulated through the jacket to provide the desired temperature.

Additionally, various catalysts and/or accelerators can be employed to accelerate copolymer degradation. Catalysts include metals or metal salts or complexes such as copper, vanadium, chromium, manganese, nickel, iron, cobalt, molybdenum and their salts and complexes such as oleates, naphthenates, octoates, carboxylates, stearates and other long chain, oil soluble, organic acid salts. Other catalysts and/or cocatalysts include the peroxides such as dibenzoyl peroxide, diocyl peroxides, and dialkyl peroxides. Suitable peroxide catalysts are disclosed in U.S. Pat. No. 3,313,793, incorporated herein by reference to the extent permitted. One type of catalytic, oxidative, shear process is disclosed in U.S. Pat. No. 5,006,608, granted Apr. 9, 1991, incorporated herein by reference to the extent permitted.

Generally, the period of time required to achieve the desired reduction in molecular weight or to reach the target SSI or thickening efficiency varies depending upon the temperature, RPM and horsepower of the mixer, and type and amount of catalyst used (if any). However, a time period of about 2 minutes to about 12 hours is generally adequate depending upon the degree degradation desired.

Another method for mechanically degrading or shearing of an ethylene-alpha-olefin copolymer comprises oxidizing the copolymer in a closed cavity in which are disposed shearing blades. A typical apparatus of this type is a device containing counter-rotating helical blades known as a “Brabender Torque Rheometer”. Typically, means can be provided for supplying air, oxygen, or another oxygen-containing gas to the shearing cavity of the vessel or it can be operated in the absence of added gases. Alternatively, or additionally, the oxidation source may be a nongaseous material such as a peroxide, placed in the reaction chamber with the copolymer; this can also have a beneficial effect on the reaction rate. It is preferred, however, that a gaseous source of oxygen be used. Although normally an outside source of gaseous oxygen is provided, this is not absolutely necessary. When the usual outside source is used, however, the gas may be supplied to the shearing cavity at any convenient flow rate. Normally, air or oxygen is provided at a rate sufficient to exchange all the air or oxygen in the shearing cavity every few seconds. Means are also provided for maintaining the shearing cavity at an elevated temperature, usually in the range of about 170° C. to 230° C., preferably 180° C. to 225° C.

Mechanical degradation or shearing processes may also be carried out under an inert gas or atmosphere such as nitrogen, as well as in the substantial absence of oxygen. Such shear assisted degradation processes carried out under an inert atmosphere can use a masticator, rubber mill, Banbury mixer, Brabender mixer, extruder or another mechanical mixing device which is capable of mixing or kneading the ethylene-alpha-olefin copolymer at elevated temperatures with the other components of the reaction, if any, into a homogeneous mass so that degradation takes place in the solid or melt state. Combinations of equipment may also be used, e.g., use of a low temperature mixer or blending device to premix the ingredients, following which the composition is transferred to a high temperature heated mixer or shearing device in which degradation occurs.

A preferred degradation method is carried out using free radical initiators such as peroxides, and preferably those that have a boiling point greater than about 100° C. Representative of such free-radical initiators are di-lauroyl peroxide, 2,5-di-methyl-hex-3-yne-2,5-bis-tertiary-butyl peroxide (sold as Lupersol 130) or its hexane analogue, di-tertiary butyl peroxide and dicumyl peroxide. The presence of an acid or acid anhydride, e.g. maleic anhydride, with the peroxide can be useful in promoting decomposition of the peroxide in order to activate it. Other peroxide activators are disclosed in EP-A-0123424, including hydroperoxides such as cumene hydroperoxide, hydrogen peroxide, tertiary butyl hydroperoxide, etc. The initiator is generally used at a concentration of from about 0.005% to about 1%, e.g. from about 0.05 to about 0.5%, based on the total weight of the olefin copolymer, and temperatures of about 120° C. to 250° C.

Free radical initiator promoted degradation is typically carried out at from about 120° C. to about 250° C., preferably from about 150° C. to about 220° C. An inert atmosphere, such as that obtained by nitrogen blanketing is used. The total time for degradation ranges from about 0.005 to about 12 hours. If carried out in an extruder, the degradation time will be shorter, e.g. from about 0.005 to about 0.2 hours. Typically, to conduct the process in a masticator it will take from about 0.5 to about 6 hours, preferably from about 0.5 to about 3 hours. The degradation reaction will be usually carried out for a time period equal to at least about 4 times, preferably at least about 6 times, the half-life of the free-radical initiator at the reaction temperature employed, e.g. with 2,5-dimethyl hex-3-yne-2, 5-bis(t-butyl peroxide) 2 hours at 160° C. or one hour at 170° C., etc. Degradation can take place by heating and mixing the copolymer with the initiator, preferably under shearing stress.

Another molecular weight degradation process involves thermal degradation of the copolymer in the substantial absence of oxygen. In this process the ethylene-alpha-olefin copolymer is heated in the presence of a catalytically effective amount of catalyst, preferably from about 0.075% to about 10%, in the absence of oxygen and to a temperature of from about 275° C. to about 450° C. or higher (particularly when using superatmospheric pressure conditions), preferably to a temperature of from about 300° C. to 400° C. The reaction time will vary depending upon the temperature, catalyst type and amount used and the extent of molecular weight reduction desired or the target properties to be achieved, e.g., SSI. Employing catalysts in amounts and at temperatures within the upper ends of the above-mentioned respective ranges, the heating or reaction time can be as little as five minutes; using an amount of catalyst in the lower end of the lower temperature range, the heating or reaction time can be from about four to five hours.

Useful catalysts for the anaerobic process are generally those known in the art for thermal degradation processes and include: an oxide or carbonate of an alkali metal, alkaline earth metal, or a heavy metal, namely, antimony, bismuth, cadmium, chromium, copper, iron lead, mercury, tantalum, titanium, thallium, vanadium and zinc; metal salts of aminocarboxylic, dicarboxylic or tricarboxylic aliphatic, phenyl or naphtyl carboxylic acid such as those disclosed in U.S. Pat. No. 3,332,926, incorporated herein by reference to the extent permitted; and the like.

Heating of the copolymer and catalyst mixture can be carried out in any suitable closed equipment such as a batch reactor or continuous reactor through which the mixture of polymer and catalyst is passed continuously for the necessary residence time to produce the desired lower molecular weight copolymer. The process can be carried out under vacuum, at ambient pressure or under superatmospheric pressure conditions. Heating can be carried out under a blanket of nitrogen or other oxygen-free atmosphere or by injecting an inert gas such as nitrogen into an extruder during the process. Alternatively, the mixture of catalyst and polymer can be heated under static conditions or stirred or agitated during heating.

Thermal oxidative degradation involves heating in the presence of oxygen or air the ethylene-alpha-olefin copolymer at a temperature of at least about 100° C. so as to cause the desired degree of degradation of the copolymer. A particularly useful method of preparing the oxidized and degraded copolymer involves heating a fluid solution of copolymer in an inert solvent and bubbling oxygen or air through the solution at a temperature of at least 100° C., preferably at least about 150° C. The process may be carried out at a temperature as high as 250° C. or even higher. In lieu of oxygen or air, any mixture of oxygen and inert gas such as nitrogen or carbon dioxide may be used. The inert gas thus functions as a convenient means of introducing oxygen into the reaction mixture.

Inert diluents useful for dissolving or dispersing the copolymer are preferably liquid inert hydrocarbons such as naphtha, hexane, cyclohexane, dodecane, xylene or toluene as well as polar diluents or mixtures thereof. The amount of the diluent to be used is not critical provided that it is sufficient to dissolve or substantially disperse the copolymer. The mixture will typically contain from about 60 to 95% diluent although more or less dilute mixtures or solutions can be prepared depending on the available equipment and economics of the process.

The copolymers of the instant invention may also be degraded to lower molecular weight by the process of homogenization, also known in the art. In the homogenization process the copolymer is generally in solution or dispersed in a diluent such as those described above. The solution or dispersion is forced at high pressure through a device that utilizes throttle valves and/or narrow orifices. Such a device is capable of generating very high shear rates and shear stress. Commercial devices such as that available from the Manton-Gaulin Manufacturing Company or equivalents thereof may be employed. Such equipment is typically operated at pressures exceeding atmospheric pressure and up to about 20,000 psi (138 MPa) in order to generate the necessary shear; it can be operated in a batch or continuous mode as is convenient.

Mixtures

Each of the above described methods of degrading the ethylene alpha-olefin copolymer can be applied to at least one copolymer; preferably the method selected is applied to two or more copolymers; if desired, it can be applied to three or more; e.g., it can be applied to as many copolymers as are necessary to achieve the target property of interest. In those instances where more than one copolymer is degraded, the copolymers can be selected based on specific properties or characteristics. For example, a copolymer that is substantially amorphous and a copolymer that is partially crystalline can be degraded, either simultaneously or sequentially (e.g., in the presence of one another, one following the other or individually first and then subsequently mixed with one another). Such copolymers in their undegraded form would be expected to differ from one another compositionally and/or have different properties in view of their different crystallinity levels; e.g., they would probably have different ethylene contents and their starting SSI values would differ. Such copolymers could then be degraded to achieve a target SSI level and the degraded copolymers would subsequently be blended with an undegraded copolymer (corresponding to the starting materials or differing therefrom in order to achieve the final target value of SSI. In this manner, not only can the undegraded copolymers be selected based on their anticipated response to the degradation process, but the undegraded copolymer or copolymers to be used in such a mixture can be independently selected, knowing that the undegraded copolymer(s) will not be subjected to a degradation process.

Blending of degraded and undegraded copolymers can be accomplished by various convenient means known in the art. For example, solid polymers can be mixed in an internal mixer such as a Banbury or Bramley Beken Blade Mixer as described above, but using only moderately elevated temperature and mild shearing conditions. In other words, the level of temperature and shear used is sufficient to substantially uniformly disperse the copolymers to be blended, but insufficient to further significantly degrade the copolymers. Typical blending temperatures can be in the range of from about 120° C. to about 150° C. Alternatively, the copolymers can be blended using an extruder or rubber mill, again selecting conditions suitable for blending rather than degrading. Such processes can be carried out batch-wise or continuously. In a continuous process, e.g., undegraded copolymer can be fed to an extruder at a downstream location (controlled at a lower temperature and at a screw location having deeper flights and causing less shear) after the degradation process has been carried out upstream on the initial copolymer(s). In each instance, such blending is preferably carried out in the presence of an atmosphere inert or substantially inert, for the copolymers, e.g., nitrogen, in order to minimize or eliminate further degradation (e.g., the measured SSI of each of the copolymers is the same after exposure to the blending conditions as before, within the error of the test measurement).

Blending of the final mixture can also be accomplished at moderately elevated temperature and limited shearing using a diluent or solvent selected from those described above, including, in particular, a lubricating oil or base stock. In this manner, degraded copolymer(s) that are already mixed with diluent as a consequence of the degradation process can be blended with the undegraded copolymer using the same diluent. If the degraded copolymer(s) are in solid form, then blending with solid undegraded copolymer (or undegraded copolymer in the form of a concentrate) also can be accomplished in a diluent.

In a preferred application of the advance taught herein, a viscosity modifier having an intermediate SSI is prepared from high SSI and low SSI components, the ethylene content of the intermediate SSI product not limited to the same extent as prior art products having the target SSI. For example, the low SSI component can be a degraded mixture of a high and low ethylene EAO such as an ethylene-propylene copolymer, also referred to as an olefin copolymer or “OCP”. The high SSI component can be a directly polymerized, i.e., undegraded, high ethylene OCP or a directly polymerized low ethylene OCP or a physical mixture (i.e., moderate conditions not resulting in degradation) of high and low ethylene copolymers. As a consequence of the use of high and low ethylene content copolymers in the mixture, an intermediate SSI OCP can be prepared having different concentrations of ethylene; in this manner ethylene concentration of the product can be fine tuned to balance other performance properties that may be affected.

In carrying out the invention, the shear stability index (SSI) of the degraded component of the mixture, (A), is from about 10 to about 40, preferably from about 15 to about 30. The SSI of the undegraded component, (B), as well as the SSI of copolymer prior to degradation that is used to prepare component (A), is from about 25 to about 80, preferably from about 30 to about 70, more preferably from about 35 to about 60; provided, however, that the SSI of component B is higher than that of component A. Consequently, the SSI of the final mixture of degraded and undegraded components is from about 15 to about 75, preferably from about 17 to about 65, more preferably from about 20 to about 55; for example, from about 20 to about 50. The ratio of degraded to undegraded ethylene-alpha-olefin components can be from about 5:95 to about 95:5, preferably from about 10:90 to about 90:10, more preferably from about 15:85 to about 85:15; for example from about 30:70 to about 70:30 and including from about 40:60 to about 60:40. In a particularly preferred embodiment, the degraded component itself is a mixture of substantially amorphous and partially crystalline ethylene-alphaolefin-copolymers, wherein each of the copolymers has been simultaneously degraded in the presence of one another according to any of the methods described hereinabove, or wherein each has been individually degraded according to the methods described above and then the individually degraded copolymers have been blended or mixed with one another to form the degraded component (A) of the final viscosity index improver mixture. Where a mixture of (i) substantially amorphous and (ii) partially crystalline ethylene alphaolefin copolymers are utilized for the degraded component, the ratio of (i) to (ii) typically can be from about 5:95 to about 95:5, preferably from about 10:90 to about 90:10, more preferably from about 15:85 to about 85:15; for example from about 30:70 to about 70:30 and including from about 40:60 to about 60:40. Various useful permutations and combinations of such blends can be set forth in tabulated form as follows:

TABLE 1
USEFUL MIXTURES^{a}

| | (A) DEGRADED | | (B) UNDEGRADED | |
|---|---|---|---|---|
| | SUB- | PARTIALLY | SUB- | PARTIALLY |
| | STANTIALLY | CRYS- | STANTIALLY | CRYS- |
| No. | AMORPHOUS | TALLINE | AMORPHOUS | TALLINE |
| 1 | 1 | 0 | 1 | 0 |
| 2 | 1 | 0 | 0 | 1 |
| 3 | 1 | 0 | 1 | 1 |
| 4 | 0 | 1 | 1 | 0 |
| 5 | 0 | 1 | 0 | 1 |
| 6 | 0 | 1 | 1 | 1 |
| 7 | 1 | 1 | 1 | 0 |
| 8 | 1 | 1 | 0 | 1 |
| 9 | 1 | 1 | 1 | 1 |

Footnote:
^{a}“1” indicates the presence of the component, “0” its absence.

Whereas each of the blends are capable of being made and used, mixtures 4, 6, 7, 8 and 9 are of interest, and mixtures 8 and 9 are of particular interest for use in lubricating oils.

The degraded ethylene-alpha-olefin copolymers, preferably ethylene-propylene copolymers, have number average molecular weights of from about 15,000 to about 300,000, preferably from about 20,000 to about 200,000, more preferably from about 20,000 to about 150,000.

The process of the present invention makes it possible to select ethylene-alpha-olefin copolymers produced by any of the above-described polymerization processes, or by any other process that may be or become available, and to use such copolymers individually or to combine them in a degradation process and independently to select undegraded ethylene alphaolefin copolymer(s) for blending therewith in order to achieve the final property or characteristic of the mixed system. The process of this invention allows for a great deal of freedom to target specific properties and also to take account of other, pragmatic variables such as raw material costs and process economics, copolymer availability and handling, etc. Consequently, one is provided with the ability to obtain a desired V.I. product having specific characteristics and marketplace value and is not limited by polymerization process variables or the need to develop new catalyst technology.

Compositions Using Degraded Ethylene Alpha Olefin Copolymer

Mixtures of the degraded and undegraded ethylene-alpha-olefin copolymers of the present invention are useful as viscosity index improvers (also referred to as viscosity modifiers) for oleaginous compositions, including partially and fully formulated lubricating oil formulations. Accordingly, a minor amount, e.g., from about 0.001 to about 49 wt. %, based on the weight of the total composition, of the oil-soluble ethylene alphaolefin copolymer mixture (of degraded and undegraded copolymer) produced in accordance with this invention can be incorporated into a major amount of an oleaginous material, such as a lubricating oil or hydrocarbon fuel, the amount selected depending upon whether one is forming finished products or additive concentrates. For convenience hereinafter, the mixture of degraded ethylene-alphaolefin copolymer plus undegraded ethylene-alphaolefin copolymer will be referred to as the “ethylene-alphaolefin copolymer mixture” or the “EAO copolymer mixture” in the singular or plural. The amount of the EAO copolymer mixture that is present in an oleaginous composition such as a lubricating oil composition, e.g., fully formulated lubricating oil composition, is an amount which is effective to improve or modify the viscosity index of said oil composition, i.e., a viscosity improving effective amount. Generally, this amount is from about 0.001 to about 20 wt. %, preferably from about 0.01 to about 15 wt. %, more preferably from about 0.1 to about 10 wt. %, for example from about 0.25 to about 5 wt. %, based on the weight of the total composition. The EAO copolymer mixtures of the invention also may be utilized in a concentrate form, e.g., from about 2 wt % up to about 49 wt. %, preferably 3 to 25 wt. %, in oil, e.g., mineral or hydrocarbon lubricating oil, for ease of handling, and may be prepared in this form by carrying out the reaction of the invention in oil as previously discussed. Alternatively, EAO copolymer mixtures in solid polymer form can be dissolved in an appropriate diluent or solvent, particularly a lubricating oil, to form the concentrate.

The lubricating oils (sometimes referred to as base oils or basestocks) to which the products of this invention can be added include not only hydrocarbon oil derived from petroleum, but also include synthetic lubricating oils such as esters of dibasic acids; complex esters made by esterification of monobasic acids, polyglycols, dibasic acids and alcohols; polyalphaolefins, polybutenes, alkyl benzenes, organic esters of phosphoric acids, polysilicone oils, etc. Thus, the products of this invention, the ethylene alphaolefin copolymer mixtures, are primarily useful as viscosity index improver or viscosity modifier additives for lubricating oil compositions and are dissolved or dispersed therein.

Base oils suitable for use in preparing the lubricating compositions of the present invention include those conventionally employed as crankcase lubricating oils for spark-ignited and compression-ignited internal combustion engines, such as automobile and truck engines, marine and railroad diesel engines, and the like. Advantageous results are also achieved by employing the additives of the present invention in base oils conventionally employed in and/or adapted for use as power transmitting fluids such as automatic transmission fluids, tractor fluids, universal tractor fluids and hydraulic fluids, heavy duty hydraulic fluids, power steering fluids and the like. Gear lubricants, industrial oils, pump oils and other lubricating oil compositions can also benefit from the incorporation therein of the additives of the present invention.

The viscosity modifier additive composition of the present invention is also effective when present in compositions in which the base oil is primarily a “Group II” and/or “Group III” basestock. These basestocks have become more important recently as automobile manufacturers and government regulators introduce more stringent performance criteria for engines and lubricating oils, particularly as directed to oil volatility and fuel efficiency. The relationship of these criteria to basestock properties and the difficulties in meeting such performance criteria is further described in Lubes'N'Greases, 6 (3), 6 (2000) and 5 (3), 26 (1999) and in the article “The Effect of High Quality Basestocks on PCMO Fuel Economy” by K. Crosthwait, et al., presented at the 1999 Lubricants & Waxes Meeting of the National Petrochemical & Refiners Association (Nov. 11-12, 1999). Group classifications or designations have been established by the American Petroleum Institute (API) according to the following table:

TABLE 2

| | | | Viscosity |
|---|---|---|---|
| Group | Saturates | Sulfur | Index |
| I | <90% | and/or | ≧80 and <120 |
| | | >0.03% | |
| II | ≧90% | ≦0.03% | ≧80 and <120 |
| III | ≧90% | ≦0.03% | ≧120 |

| | |
|---|---|
| IV | Restricted to PAOs |
| V | All other basestocks |

Most commercial Group II basestocks have had viscosity index values in the range of about 95 to about 100. Consequently, Group II basestocks having viscosity indices in the range of about 110 to 119 as well as the other characteristics of Group II basestocks have come to be unofficially identified as “Group II+” basestocks. The present invention is also useful when Group II basestocks are employed in the lubricating oil formulation, when Group II+ basestocks are used and also when Group III basestocks are used; mixtures of Group II and Group III basestocks can also be employed. Furthermore, the present invention is also useful when Group II, Group II+ and/or Group III basestocks are used in admixture with Group I basestocks, and further wherein the Group II+ and/or Group III basestocks are present in an amount of at least about 20 percent by weight. It will be observed from the above table that the viscosity index for Group III basestocks as defined by the API is open-ended, i.e., it is expressed as greater than 120. For purposes of the present invention, all Group III basestocks are suitable for use with the current invention and an upper limiting value is not necessary to be encompassed herein, i.e., if a basestock is characterized as a Group III basestock under the API scheme, it is within the scope of the present invention regardless of how high its viscosity index. However, for purposes of clarity, it can be said that Group III basestocks are expected to have a viscosity index of equal to or greater than 120 and: equal to or less than 200; preferably equal to or less than 180; most preferably equal to or less than 160. Group II and Group III basestocks are available commercially from several producers including ExxonMobil, Chevron, Petro-Canada, Excel Paralubes and Motiva Enterprises. The processes used by various manufacturers are not necessarily the same, but basestocks characterized by these “Group” designation will be understood to meet the characteristics defined above.

The oil compositions may optionally contain other conventional additives, such as for example, pour point depressants, antiwear agents, antioxidants, other viscosity-index improvers (including those having dispersant properties), dispersants, corrosion inhibitors, anti-foaming agents, detergents, rust inhibitors, friction modifiers, and the like. Each of these other additives is briefly described in the following paragraphs.

Corrosion inhibitors, also known as anti-corrosive agents, reduce the degradation of the metallic parts contacted by the lubricating oil composition. Illustrative corrosion inhibitors are phosphosulfurized hydrocarbons and the products obtained by reaction of a phosphosulfurized hydrocarbon with an alkaline earth metal oxide or hydroxide, preferably in the presence of an alkylated phenol or of an alkylphenol thioester, and also preferably in the presence of carbon dioxide. Phosphosulfurized hydrocarbons are prepared by reacting a suitable hydrocarbon such as a terpene, a heavy petroleum fraction of a C₂ to C₆ olefin polymer such as polyisobutylene, with from 5 to 30 wt. % of a sulfide of phosphorus for 0.5 to 15 hours, at a temperature in the range of about 66° C. to about 316° C. Neutralization of the phosphosulfurized hydrocarbon may be effected in the manner taught in U.S. Pat. No. 1,969,324.

Oxidation inhibitors, or antioxidants, reduce the tendency of mineral oils to deteriorate in service which deterioration can be evidenced by the products of oxidation such as sludge and varnish-like deposits on the metal surfaces, and by viscosity growth. Such oxidation inhibitors include alkaline earth metal salts of alkylphenolthioesters having preferably C₅ to C₁₂ alkyl side chains, e.g., calcium nonylphenol sulfide, barium t-octylphenyl sulfide, di-octylphenylamine, phenylalphanaphthylamine, phospho-sulfurized or sulfurized hydrocarbons, etc.

Other oxidation inhibitors or antioxidants useful in this invention comprise oil-soluble copper compounds, preferably in the form of an oil-soluble copper compound. By oil soluble it is meant that the compound is soluble in oil under normal blending conditions for preparing the formulated oil or additive package to which the oil is added. The copper compound may be in the cuprous or cupric form. The copper may be in the form of the copper dihydrocarbyl thio- or dithio-phosphates, or as the copper salt of a synthetic or natural carboxylic acid. Examples include C₁₀ to C₁₈ fatty acids, such as stearic or palmitic acid. Preferred are unsaturated acids such as oleic or branched carboxylic acids such as napthenic acids of molecular weights of from about 200 to 500, or synthetic carboxylic acids, because of the improved handling and solubility properties of the resulting copper carboxylates. Also useful are oil-soluble copper dithiocarbamates of the general formula (RR₁NCSS)ₙCu (where n is 1 or 2 and R and R₁ are the same or different hydrocarbyl radicals containing from 1 to 18, and preferably 2 to 12, carbon atoms, and including radicals such as alkyl, alkenyl, aryl, aralkyl, alkaryl and cycloaliphatic radicals. Particularly preferred as R and R₁ groups are alkyl groups of from 2 to 8 carbon atoms. Thus, the radicals may, for example, be ethyl, n-propyl, i-propyl, n-butyl, i-butyl, sec-butyl, amyl, n-hexyl, i-hexyl, n-heptyl, n-octyl, decyl, dodecyl, octadecyl, 2-ethylhexyl, phenyl, butylphenyl, cyclohexyl, methylcyclopentyl, propenyl, butenyl, etc. In order to obtain oil solubility, the total number of carbon atoms (i.e., R and R₁) will generally be about 5 or greater. Copper sulphonates, phenates, and acetylacetonates may also be used.

Other examples of useful copper compounds are copper Cu(I) and/or Cu(II) salts of alkenyl succinic acids or anhydrides. The salts themselves may be basic, neutral or acidic. They may be formed by reacting (a) polyalkylene succinimides (having polymer groups of Mn of 700 to 5,000) derived from polyalkylene-polyamines, which have at least one free carboxylic acid group, with (b) a reactive metal compound. Suitable reactive metal compounds include those such as cupric or cuprous hydroxides, oxides, acetates, borates, and carbonates or basic copper carbonate. Examples of these metal salts are Cu salts of polyisobutenyl succinic anhydride, and Cu salts of polyisobutenyl succinic acid. Preferably, the selected metal employed is in divalent form, e.g., Cu⁺². The preferred substrates are polyalkenyl succinic acids in which the alkenyl group has a molecular weight greater than about 700. The alkenyl group desirably has a Mn from about 900 to 1,400, and up to 2,500, with Mn of about 950 being most preferred. Especially preferred is polyisobutylene succinic anhydride or acid. These materials may desirably be dissolved in a solvent, such as a mineral oil, and heated in the presence of a water solution (or slurry) of the metal bearing material. Heating may take place between 70° C. and about 200° C.; temperatures of 110° C. to 140° C. are adequate. It may be necessary, depending upon the salt produced, not to allow the reaction to remain at a temperature above about 140° C for an extended period of time, e.g., longer than 5 hours, or decomposition of the salt may occur. The copper antioxidants (e.g., Cu-polyisobutenyl succinic anhydride, Cu-oleate, or mixtures thereof) are generally employed in an amount of from about 50 to 500 ppm by weight of the metal, in the final lubricating or fuel composition.

Friction modifiers serve to impart the proper friction characteristics to lubricating oil compositions such as automatic transmission fluids. Representative examples of suitable friction modifiers are found in U.S. Pat. No. 3,933,659 which discloses fatty acid esters and amides; U.S. Pat. No. 4,176,074 which describes molybdenum complexes of polyisobutenyl succinic anhydride-amino alkanols; U.S. Pat. No. 4,105,571 which discloses glycerol esters of dimerized fatty acids; U.S. Pat. No. 3,779,928 which discloses alkane phosphonic acid salts; U.S. Pat. No. 3,778,375 which discloses reaction products of a phosphonate with an oleamide; U.S. Pat. No. 3,852,205 which discloses S-carboxyalkylene hydrocarbyl succinimide, S-carboxyalkylene hydroacarbyl succinamic acid and mixtures thereof; U.S. Pat. No. 3,879,306 which discloses N(hydroxyalkyl)alkenyl-succinamic acids or succinimides; U.S. Pat. No. 3,932,290 which discloses reaction products of di- (lower alkyl) phosphites and epoxides; and U.S. Pat. No. 4,028,258 which discloses the alkylene oxide adduct of phosphosulfurized N-(hydorxyalkyl) alkenyl succinimides. The most preferred friction modifiers are succinate esters, or metal salts thereof, of hydrocarbyl substituted succinic acids or anhydrides and thiobis-alkanols such as described in U.S. Pat. No. 4,344,853.

Dispersants maintain in suspension materials resulting from oxidation during use that are insoluble in the oil, thus preventing sludge flocculation and precipitation or deposition on metal parts. Suitable dispersants include high molecular weigh alkyl succinimides, the reaction product of oil-soluble polyisobutylene succinic anhydride with ethylene amines such as tetraethylene pentamine and borated salts thereof.

Pour point depressants, otherwise known as lube oil flow improvers (LOFIs), lower the temperature at which the lubricating fluid will flow or can be poured. Typical of such additives are C₈-C₁₈ dialkylfumarate/vinyl acetate (DAF/VA) copolymers, polymethacrylates, and wax naphthalene. Mixtures of DAF/VA copolymers having specific average side chain carbon number structural characteristics are particularly useful in lubricating formulations that employ basestocks identified as Group II or Group III (i.e., having high viscosity indices). Still more particularly useful are the latter compositions in which there is used an ethylene-alpha-olefin copolymer viscosity index improver in which the ethylene level is more than about 30 wt. %, especially the viscosity index improvers disclosed and claimed herein. Contemporaneously filed, copending patent application Ser. No. ______, filed ______ describes in detail such LOFI compositions that are particularly useful herein; the disclosure of that application is incorporated herein to the extent permitted.

Foam control can be provided by an antifoamant of the polysiloxane type, e.g., silicone oil and polydimethyl siloxane.

Anti-wear agents, as their name implies, reduce wear of metal parts. Representative conventional antiwear agents are zinc dialkyldithiophosphate and zinc diaryldithiosphate.

Detergents and metal rust inhibitors include the metal salts of sulphonic acids, alkyl phenols, sulfurized alkyl phenols, alkyl salicylates, naphthenates and other oil soluble mono- and dicarboxylic acids. Highly basic (e.g., overbased) metal salts, such as highly basic alkaline earth metal sulfonates (especially Ca and Mg salts) are frequently used as detergents. Representative examples of such materials, and their methods of preparation, are found in EP-B 208,560.

Some of the above-identified additives can provide multiple effects, e.g., a dispersant-oxidation inhibitor. Compositions containing these conventional additives are typically blended into the base oil in amounts that are effective to provide their normal attendant function. Representative effective amounts of such additives are illustrated as follows:

TABLE 3

| | Wt. % a.i. | Wt. % a.i. |
|---|---|---|
| Additive | (Broad) | (Preferred) |
| Viscosity Modifier | 0.01-12 | 0.01-4 |
| Corrosion Inhibitor | 0.01-5 | 0.01-1.5 |
| Oxidation Inhibitor | 0.01-5 | 0.01-1.5 |
| Dispersant | 0.1-20 | 0.1-8 |
| Pour Point | 0.01-5 | 0.01-1.5 |
| Depressant/LOFI | | |
| Anti-Foam Agent | 0.001-3 | 0.001-0.15 |
| Anti-Wear Agent | 0.001-5 | 0.001-0.15 |
| Friction Modifier | 0.01-5 | 0.01-1.5 |
| Detergent/Rust | 0.01-10 | 0.01-3 |
| Inhibitor | | |
| Mineral Oil Base | Balance | Balance |

a.i. = active ingredient

When other additives are employed, it may be desirable, although not necessary, to prepare additive concentrates comprising concentrated solutions or dispersions of the viscosity index improver (in concentrate amounts hereinabove described), together with one or more of said other additives (said concentrate when constituting an additive mixture being referred to here in as an additive package) whereby several additives can be added simultaneously to the base oil to form the lubricating oil composition. Dissolution of the additive concentrate into the lubricating oil may be facilitated by solvents and by mixing accompanied with mild heating, but this is not essential. The concentrate or additive-package will typically be formulated to contain the viscosity index improver additive and optional additional additives in proper amounts to provide the desired concentration in the final formulation when the additive-package is combined with a predetermined amount of base oil lubricant. Thus, the products of the present invention can be added to small amounts of base oil or other compatible solvents along with other desirable additives to form additive-packages containing active ingredients in collective amounts of typically from about 2.5 to about 90 wt. %, preferably from about 5 to about 75 wt. %, most preferably from about 8 to about 50 wt. % additives in the appropriate proportions with the remainder being base oil. The final formulations typically employ about 10 wt. % of the additive package with the remainder being base oil. Each of the weight percent values expressed herein are based on active ingredient (a.i.) content of the additive, and/or upon the total weight of any additive-package or formulation which will be the sum of the a.i. weight of each additive plus the weight of total oil or diluent.

The degraded EAO copolymer mixtures of the instant invention are directly oil-soluble, dissolvable in oil with the aid of a suitable solvent, or are stably dispersible therein. Oil-soluble, dissolvable, or stably dispersible as that terminology is used herein does not necessarily indicate that the materials are soluble, dissolvable, miscible, or capable of being suspended in oil in all proportions. It does mean, however, that the additives for instance, are soluble or stably dispersible in oil to an extent sufficient to exert their intended effect in the environment in which the oil is employed. Moreover, the additional incorporation of other additives may also permit incorporation of higher levels of a particular copolymer hereof, if desired.

In another aspect of the present invention the degraded EAO copolymers, the undegraded EAO copolymers and their mixtures are grafted, derivatized and/or otherwise post-treated with grafting materials and/or other reactants to form derivatives of the EAO copolymers. Such post-treatment can be accomplished before or after forming the mixtures taught herein.

Post-treating processes involving the use of various reagents are known insofar as application to conventional undegraded EAO copolymers of the prior art (whether or not grafted), further detailed descriptions of these processes are unnecessary to enable one skilled in the art to prepare such derivatives. In order to apply the prior art processes to the compositions of this invention, all that is necessary is that reaction conditions, ratio of reactants, and the like as described in the prior art, be applied to the novel compositions of this invention. In particular reference is made to U.S. Pat. No. 5,244,590 in which the various reactions are described in further detail and which patent is incorporated herein by reference for all permitted purposes.

The materials or compounds that are grafted on the EAO copolymer backbone to form grafted EAO copolymer mixtures of the instant invention are those materials that are capable of being grafted onto said copolymers. These materials are generally well known in the art as grafting materials for conventional olefin polymers, e.g., ethylene-alpha-olefin copolymers, and are generally commercially available or may be readily prepared by well-known conventional methods. The grafting materials preferably contain olefinic unsaturation and further preferably contain at least one of carboxylic acid moiety, anhydride moiety, hydroxyl moiety, sulfur atom, nitrogen atom, and oxygen atom. The olefinically unsaturated portion, i.e., ethylenically unsaturated portion, is one that is capable of reacting with the ethylene copolymer backbone and upon reaction therewith generally becomes saturated.

These materials include, for example, unsaturated mono- and polycarboxylic acids, preferably the C₄-C₁₀ acids, preferably with at least one olefinically unsaturated position, and anhydrides, salts, esters, ethers, amides, nitrites, thiols, thioacids glycidyl, cyano, hydroxy, glycol and other substituted derivatives of said acids. Preferred carboxylic acid grafting materials are (i) the monounsaturated C₄ to C₁₀ dicarboxylic acids wherein (a) the carboxyl groups are vicinyl (i.e., located on adjacent carbon atoms), and (b) at least one, preferably both, of the adjacent carbon atoms are part of said mono unsaturation; or (ii) derivatives of (i) such as anhydrides or C₁ to C₅ alcohol derived mono- or diesters of (i). Upon reaction with the EAO copolymer, the monounsaturation of the dicarboxylic acid, anhydride, or ester becomes saturated. Thus, for example, maleic anhydride becomes an EAO substituted succinic anhydride. Examples of such acids, anhydrides and derivatives thereof include maleic acid, fumaric acid, himic acid, itaconic acid, citraconic acid, acrylic acid, glycidyl acrylate, cyanoacrylates, hydroxy C₁-C₂₀ alkyl methacrylates, acrylic polyethers, acrylic anhydride, methacrylic acid, crotonic acid, isocrotonic acid, mesaconic acid, angelic acid, maleic anhydride, itaconic anhydride, citraconic anhydride, himic anhydride, acrylonitrile, methacrylonitrile, sodium acrylate, calcium acrylate, and magnesium acrylate.

Grafting of the EAO copolymers and mixtures with grafting materials may be accomplished by conventional and well-known grafting processes. Grafted EAO copolymer mixtures are useful as a viscosity index improver and/or multifunctional viscosity index improver for oleaginous compositions, particularly lubricating oil compositions. These well-known and conventional processes include thermal grafting by the “ene” reaction, using copolymers containing unsaturation, either chlorinated or unchlorinated, or preferably by free-radical induced grafting in solvent, preferably in a mineral lubricating oil as solvent; these are described in further detail in U.S. Pat. No. 5,244,590, as noted above. Useful amounts of the grafted or otherwise modified EAO copolymer mixtures in base oil are the same as described hereinabove with respect to ungrafted or unmodified mixtures. Similarly, the grafted or otherwise modified EAO copolymer mixtures can be used alone or in combination with the other additives described above.

Post-treating processes involving the use of various reagents are known insofar as application to conventional undegraded EAO copolymers of the prior art (whether or not grafted), further detailed descriptions of these processes are unnecessary to enable one skilled in the art to prepare such derivatives. The prior art processes can be applied to the novel compositions of this invention by adjusting reaction conditions, for example, the ratio of reactants, and the like as described in the prior art. For example, as noted previously, U.S. Pat. No. 5,244,590 describes in detail various grafting and derivatizing reagents and reactions which can be applied.

### EXAMPLES

The following examples further illustrate the present invention. The examples are presented by way of illustration and do not limit the invention thereto. Unless otherwise indicated, all parts and percentages are on a weight basis.

Table 4 summarizes the copolymers used to prepare and test several mixtures:

TABLE 4

| | Ethylene | | | | | Crystal- |
|---|---|---|---|---|---|---|
| | Content | M_{w}³ | | | | linity |
| Polymer¹ | (wt %)² | (× 10⁻³) | M_{w}/Mₙ³ | TE⁴ | SSI (%)⁴ | (%)⁵ |
| A | 68.5 | 135 | 2.1 | 2.90 | 40 | 9.7 |
| B | 47.0 | 207 | 1.9 | 3.24 | 56 | 0.1 |
| C | 62.9 | 151 | 2.4 | 2.95 | 46 | — |
| D | 59.6 | 88.7 | 2.2 | 2.12 | 24 | 6.1 |
| Footnotes: | | | | | | |
| ¹All are ethylene-propylene copolymers produced in a Ziegler-Natta CSTR process: | | | | | | |
| A, B = undegraded, commercial OCPs | | | | | | |
| C = physical mixture of 80 wt % A and 20 wt % B | | | | | | |
| D = copolymer mixture of 60 wt % A and 40 wt % B degraded in a high temperature/high shear extrusion process | | | | | | |
| ²Ethylene content measured by proton NMR at 50° C. Samples were prepared with 0.3 grams of polymer diluted to a total weight of 1.0 gram in chloroform (CDCl₃) . A 10.0 second delay time was used between scans; 400 scans; pulse angle 90°. | | | | | | |
| ³M_{w}, and M_{w}/Mₙ measured using GPC equipped with light scattering, refractive index and differential viscosity detectors. Trichlorobenzene carrier at a flow rate of 0.5 ml/min., 135° C. M_{w} measured by the light scattering detector, M_{w}/Mₙ by refractive index detector. Calibrated using commercially available polystyrene and polyethylene standards under the same conditions. | | | | | | |
| ⁴Thickening Efficiency (TE) and Shear Stability Index (SSI) are measured in a reference oil having a kinematic viscosity of 4.67 to 4.77, typically about 4.75, by ASTM D445. The oil is one in which the polymer or copolymer remains soluble. In addition, a blend of different grades of oil is also suitable for use as a reference oil, provided the kinematic viscosity and solubility of the polymer in the oil are maintained. Thickening efficiency is calculated according | | | | | | |
| # to the equation hereinabove. For copolymers A and B and mixture C, c, the polymer concentration was 1 wt. % polymer in the reference oil; for mixture D, c was 1.5 wt % polymer in the reference oil. Shear stability index was measured according to ASTM D6278, and is also calculated according to the equation hereinabove. | | | | | | |

⁵Crystallinity was measured by differential scanning calorimetry (DSC) under the following conditions: polymer sample annealed at room temperature for at least 24 hours before the measurement; sample first cooled to −100° C. from room temperature, and then heated to 150° C. at 10° C/min. Crystallinity was calculated according to the previously defined equation.

### Examples 1-8

The mixtures shown in Table 5 were prepared using the copolymer components described in Table 4, above. Table 5 summarizes the compositions and measured properties:

TABLE 5

| Mixture | 1 | 2 | 3 | 4 | 5 | 6 | 7 | 8 |
|---|---|---|---|---|---|---|---|---|
| Component | | | | | | | | |
| A | — | — | — | — | 40% | 50% | 60% | 70% |
| C | 40% | 50% | 60% | 70% | — | — | — | — |
| D | 60% | 50% | 40% | 30% | 60% | 50% | 40% | 30% |
| Property | | | | | | | | |
| TE¹ | 2.36 | 2.45 | 2.53 | 2.63 | 2.33 | 2.42 | 2.49 | 2.55 |
| SSI (%)¹ | 36 | 38 | 39 | 40 | 36 | 35 | 37 | 36 |
| Calculated | 60.9 | 61.3 | 61.6 | 61.9 | 63.2 | 64.1 | 64.9 | 65.8 |
| ethylene | | | | | | | | |
| content | | | | | | | | |
| (wt %)² | | | | | | | | |

Footnotes:
¹TE and SSI determined in reference oil (described above) containing 1.4 wt % polymer.
²Ethylene content calculated based on the ethylene contents of the copolymers and copolymer mixtures reported in Table 4.

The present invention allows production of polymers having a similar SSI, but differing in ethylene content; note the results in Table 5 for mixtures 1, 5, 6, 7 and 8, wherein the SSI values range from 35 to 37.

Low temperature viscometric properties of samples 1, 5 and 8 (each physical mixtures of OCP copolymers as described above) were further evaluated, and compared with commercial OCP viscosity modifiers. Tables 6 summarizes the formulations and their low temperature viscometric properties:

TABLE 6

| | | | | | Mixture | Mixture | Mixture |
|---|---|---|---|---|---|---|---|
| | | | VM-1⁴ | VM-II⁵ | 1 | 5 | 8 |
| Formula- | Component | SAE | | | 40 wt % | 40 wt % | 70 wt % |
| tion | | 5W30 | | | C + 60 | A + 60 | A + 30 |
| (SAE | | Limit | | | wt % D | wt % D | wt % D |
| 5W30 | | | | | | | |
| Target) | | | | | | | |
| Infineum | DI^{a} | | 10.00 | 10.00 | 10.00 | 10.00 | 10.00 |
| P5021 | | | | | | | |
| Exxon | Group I | | 87.02 | 87.02 | 86.87 | 86.85 | 86.93 |
| 100N | Basestock | | | | | | |
| Exxon | Group I | | 2.00 | 2.00 | 2.00 | 2.00 | 2.00 |
| 325N | Basestock | | | | | | |
| PPD | PPD | | 0.20¹ | 0.20³ | 0.30² | 0.30³ | 0.30³ |
| VM Treat | VM | | 0.78 | 0.78 | 0.83 | 0.85 | 0.77 |
| | Polymer | | | | | | |
| Total | | | 100 | 100 | 100 | 100 | 100 |
| Property | ASTM Test | | | | | | |
| Kv100 | D 445 | 9.3- | 11.00 | 11.14 | 11.02 | 11.04 | 11.07 |
| (cSt) | | 12.5 | | | | | |
| CCS at | D 5293 | <3500 | 3190 | 3270 | 2810 | 3240 | 3150 |
| −25° C. | | | | | | | |
| (cp) | | | | | | | |
| MRV/TP-1 | D 4684 | <60000 | 26700 | 38000 | 25800 | 30300 | 29700 |
| at | | | | | | | |
| −35° C. | | | | | | | |
| (cp) | | | | | | | |
| Yield | D 4684 | <35 | <35 | <35 | <35 | <35 | <35 |
| Stress | | | | | | | |
| (Pa) | | | | | | | |

Footnotes:
^{a}Detergent Inhibitor (DI) : A typical detergent inhibitor package includes the following components: dispersant, detergent, friction modifier, antifoam agent, antiwear agent and antioxidant. The components are dispersed or dissolved in a lubricating oil basestock.
¹Infineum V385, a commercial fumarate/vinyl acetate pour point depressant (Infineum USA L.P., Linden, NJ).
²LZ6662, a commercial pour point depressant marketed by The Lubrizol Corporation (Wickliffe, Ohio).
³Infineum V390, a commercial fumarate/vinyl acetate pour point depressant.
⁴VM-I, a commercial OCP viscosity modifier product designated as 33 SSI. The polymer is reported to be a high ethylene content, semi-crystalline ethylene-propylene copolymer.
⁵VM-II, a commercial OCP viscosity modifier product designated as 35 SSI. The polymer is a semi-crystalline ethylene-propylene copolymer with an ethylene content of 60.1 wt % as measured by proton NMR. GPC analysis of this copolymer also indicated the presence of long chain branching.

These oil compositions are based on Exxon brand Group I basestocks and a passenger car motor oil detergent inhibitor package. They were blended to a kinematic viscosity of 11.0±0.2 cSt (at 100° C.). Mixtures 1, 5 and 8 are shown to be useful lubricating oil viscosity modifiers and further exhibit similar low temperature performance properties at similar treat rates compared to the two commercial OCP viscosity modifier products. Additionally, all the oil samples also met SAE J300 5W30 low temperature requirements.

### Examples 9-11

Compositions based on the polymer mixtures 1, 5 and 8 as described above were prepared using a “Group II” type basestock and their properties determined. The compositions and test results are shown in Table 7:

TABLE 7

| Group II | | | | | |
|---|---|---|---|---|---|
| Basestock | | | Mixture | Mixture | Mixture |
| Study | | | 1 | 5 | 8 |
| Formulation | Component | SAE | 40 wt % | 40 wt % | 70 wt % |
| | | 5W30 | C + 60 | A + 60 | A + 30 |
| | | Limit | wt % D | wt % D | wt % D |
| DI Package¹ | — | | 9.75 | 9.75 | 9.75 |
| Exxon 100N² | Group I | | 9.70 | 9.96 | 9.17 |
| | Basestock | | | | |
| IOL120X³ | Group II | | 79.52 | 79.24 | 80.09 |
| | Basestock | | | | |
| Pour Point | Infineum | | 0.30⁴ | 0.30⁴ | 0.30⁴ |
| Depressant | V385⁴ | | | | |
| Viscosity | EP | | 0.73 | 0.75 | 0.69 |
| Modifier | Copolymers | | | | |
| Total | | | 100 | 100 | 100 |
| Property | ASTM Test | | | | |
| Kv100 (cSt) | D 445 | 9.3- | 10.16 | 10.18 | 10.20 |
| | | 12.5 | | | |
| CCS at −25° | D 5293 | <3500 | 2510 | 2490 | 2440 |
| C. (cp) | | | | | |
| MRV/TP-1, at | D 4684 | <60000 | 40300 | 27600 | 26500 |
| −35° C. (cp) | | | | | |
| YS < (Pa) | D 4684 | <35 | 35 | 35 | 35 |

Footnotes:
¹Detergent inhibitor package includes components as described in footnote “a” of Table 6.
²Exxon 100N diluent oil used in the viscosity modifier concentrate.
³Imperial Oil Limited (IOL, Canada) brand Group II basestock, grade as indicated.
⁴Infineum V385 is a commercial fumarate/vinyl acetate pour point depressant.

As shown, the oil compositions were based on a Group II basestock; they were blended to a kinematic viscosity of 10.20±0.2 cSt (at 100° C). Mixtures 1, 5 and 8 exhibited useful viscosity modifying properties in this alternative basestock. Furthermore, the mixtures each met SAE J300 5W30 low temperature requirements.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Oil soluble viscosity index improver composition comprising a mixture of: (A) at least one molecular weight degraded copolymer of ethylene and at least one other alpha-olefin monomer; and (B) at least one substantially undegraded copolymer of ethylene and at least one other alpha-olefin monomer.

2. The mixture according to claim 1 wherein said copolymer (A) prior to degradation and said copolymer (B) are produced by olefin polymerization processes selected from the group consisting of those employing tubular, batch and continuous stirred tank reactors; and catalyst systems selected from the group consisting of Ziegler-Natta, metallocene, constrained geometry and diimine.

3. The mixture according to claim 2 wherein said copolymer (A) prior to degradation comprises ethylene in the range of from about 20 to about 90 wt. %; a molecular weight distribution characterized by the ratio of weight average molecular weight to number average molecular weight, Mw/Mn, of from greater than about 1 to about 8; Mn of from about 25,000 to about 500,000; a degree of crystallinity such that said copolymer is from substantially amorphous up to about 25 wt. % crystalline; and a shear stability index of from about 25 to about 80.

4. The mixture according to claim 3 wherein said ethylene copolymer in (A) and/or (B) further comprises from greater than zero to about 20% by weight of said copolymer of a non-conjugated diene.

5. The mixture according to claim 1 wherein said degraded ethylene-alpha-olefin copolymer is degraded by a process selected from the group consisting of mechanical degradation, shear degradation, thermal degradation and homogenization, wherein each process is conducted in a substantially inert atmosphere or in the presence of oxygen and, further, wherein each process is conducted in the presence or absence of at least one degradation assisting catalyst.

6. The mixture according to claim 5 wherein said degradation process comprises shear assisted thermal oxidative degradation.

7. The mixture according to claim 6 further wherein said degradation process is carried out in the presence of at least one degradation assisting catalyst.

8. The mixture according to claim 1 wherein the shear stability index of component (A) is from about 10 to about 40.

9. The mixture according to claim 8 wherein the shear stability index of component (B) is from about 30 to about 70.

10. The mixture according to any of claims 8 and 9 wherein the shear stability index of said mixture is from about 17 to about 65.

11. The mixture according to claims 10 wherein the shear stability index of said mixture is from about 20 to about 55.

12. The mixture according to claim 1 wherein component (A) comprises at least one substantially amorphous copolymer of ethylene.

13. The mixture according to claim 1 wherein component (A) comprises at least one partially crystalline copolymer of ethylene.

14. The mixture according to claim 1 wherein component (A) comprises a blend of: (i) substantially amorphous copolymer; and (ii) partially crystalline copolymer.

15. The mixture according to claim 14 wherein the ratio of (i):(ii) is from about 10:90 to about 90:10.

16. The mixture according to claim 14 wherein component (B) comprises a substantially amorphous copolymer.

17. The mixture according to claim 16 wherein the ratio of (A):(B) is from about 5:95 to about 95:5.

18. The mixture according to claim 14 wherein component (B) is selected from the group consisting of partially crystalline copolymer and substantially amorphous copolymer.

19. The mixture according to claim 1 wherein component (B) comprises a blend of: (i) substantially amorphous copolymer; and (ii) partially crystalline copolymer.

20. A lubricating composition exhibiting improved viscometric properties comprising (1) lubricating oil and (2) the mixture of claim 1.

21. The lubricating composition according to claim 20 which contains from about 0.01 to about 20 wt. % of (2).

22. A viscosity index improver concentrate composition comprising (1) lubricating oil and (2) the mixture of claim 1.

23. The composition according to claim 22 wherein (2) is present at from about 2 to about 49 wt. %.

24. The composition according to any of claims 20 and 23 and further comprising at least one lubricating oil flow improver.

25. A process for modifying the shear stability index of a viscosity index improver polymer or copolymer mixture to a desired target shear stability index comprising shear degrading at least one first viscosity index improver polymer or copolymer to a lower, specific shear stability index and mixing therewith at least one substantially undegraded second polymer or copolymer having a shear stability index different from said first polymer or copolymer to obtain a mixture having said target shear stability index.

26. The process of claim 25 wherein said degraded polymer or copolymer is degraded by a process selected from the group consisting of mechanical degradation, thermal degradation and homogenization, wherein each process is conducted in a substantially inert atmosphere or in the presence of oxygen and, further, wherein each process is conducted in the presence or absence of at least one degradation assisting catalyst.

27. The process according to claim 26 wherein said degradation process comprises shear assisted thermal oxidative degradation.

28. The process according to claim 27 further wherein said degradation process is carried out in the presence of at least one degradation assisting catalyst.

29. Oil soluble viscosity index improver comprising a mixture of (A) molecular weight degraded mixture of substantially amorphous ethylene alphaolefin copolymer and partially crystalline ethylene alphaolefin copolymer, said mixture (A) having a shear stability index that is lower than said ethylene alphaolefin copolymers prior to said degradation, and (B) at least one undegraded ethylene alphaolefin copolymer.

30. The viscosity index improver of claim 29 having a shear stability index of from about 20 to about 45.
